(19) United States
(12) Patent Application Publication
(10) Pub. No.: US 2009/0241016 A1
(43) Pub. Date: Sep. 24, 2009

(54) DISPLAY CONTROL APPARATUS, DISPLAY CONTROL METHOD AND COMPUTER PRODUCT

(75) Inventors: Hideto Kihara, Kawasaki (JP); Kazuki Matsui, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/364,926

(22) Filed: Feb. 3, 2009

(30) Foreign Application Priority Data
Mar. 24, 2008 (JP) 2008-76297

(51) Int. Cl. G06F 17/00

(52) U.S. Cl. 715/205

(57) ABSTRACT

A display control apparatus acquires a Web page from a Web server to transmit the Web page to a user terminal. The display control apparatus receives, from the user terminal, a request for access to a second Web page among link destination Web pages of a first Web page in which a link to one or a plurality of the link destination Web pages is embedded; extracts, from the first Web page, a keyword relevant to the second Web page; detects a notable portion, serving as a portion relevant to the keyword, in the second Web page; and sets a display priority of a notable part including the notable portion of the second Web page so that the display priority of the notable part is higher than that of an accessory part serving as a part other than the notable part.

### CROSS-REFERENCE TO RELATED APPLICATIONS

This application is based upon and claims the benefit of priority of the prior Japanese Patent Application No. 2008-76297, filed on Mar. 24, 2008, the entire contents of which are incorporated herein by reference.

### BACKGROUND

1. Field

The present invention relates to a technique for controlling the display of a Web page.

2. Description of the Related Art

With the advancement of a broadband network such as the Internet, transmission and reception of massive amounts of data are enabled. Further, a CMS (Contents Management System) and the like are coming into widespread use, and links to various pieces of information can be embedded in a Web page by simply using a template. Various pieces of information whose information amounts are large can be embedded in a Web page. Such pieces of information include an advertisement, a link to a past article, a link to relevant information and a relevant image. Furthermore, the increase in complexity and variety of structures of a Web site and each Web page is enabled by the utilization of a script language, a plug-in, etc.

A user acquires a Web page, in which desired information is displayed, by following a link within a Web page. A technique described in Non-Patent Document 1 has been proposed, for example, in order to allow a Web page containing desired information to be rapidly displayed. A Web page is divided into a plurality of blocks in the technique described in Non-Patent Document 1. A Web page relevant to this block is subsequently displayed when a user has selected a block containing desired information. Thus, the technique described in Non-Patent Document 1 enhances the operability in selecting desired information, and provides the desired information rapidly.

[Non-Patent Document 1] “Development of a technique for comfortably browsing a Web page for a PC on a cellular phone”, Nov. 24, 2006.

### SUMMARY

A display control apparatus disclosed in the present application serves as a display control apparatus for acquiring a Web page from a Web server to transmit the Web page to a user terminal, wherein the display control apparatus includes: an access request receptor for receiving, from the user terminal, a request for access to a second Web page among link destination Web pages of a first Web page in which a link to one or a plurality of the link destination Web pages is embedded; a keyword extractor for extracting, from the first Web page, a keyword relevant to the second Web page; a notable portion detector for detecting a notable portion, serving as a portion relevant to the keyword, in the second Web page; and a display controller for setting a display priority of a notable part including the notable portion of the second Web page so that the display priority of the notable part is higher than that of an accessory part serving as a part other than the notable part.

A user terminal disclosed in the present application serves as a user terminal for acquiring a Web page from a Web server to display the Web page, wherein the user terminal includes: an access request receptor for receiving a request for access to a second Web page among link destination Web pages of a first Web page in which a link to one or a plurality of the link destination Web pages is embedded; a keyword extractor for extracting, from the first Web page, a keyword relevant to the second Web page; a notable portion detector for detecting a notable portion, serving as a portion relevant to the keyword, in the second Web page; a display controller for setting a display priority of a notable part including the notable portion of the second Web page so that the display priority of the notable part is higher than that of an accessory part serving as a part other than the notable part; and a display for displaying the second Web page in accordance with the display priority.

It should be noted that the application of constituent elements of the display control apparatus disclosed in the present application or any combination of the constituent elements to a method, an apparatus, a circuit, a system, a computer program, a recording medium, a data structure, etc. is also effective as other aspect of the present invention.

The above-described embodiments of the present invention are intended as examples, and all embodiments of the present invention are not limited to including the features described above.

### BRIEF DESCRIPTION OF THE DRAWINGS

FIG. 1 illustrates a network configuration diagram according to Embodiment 1 of the present invention;

FIG. 2 illustrates a screen example of a URL 0 page;

FIG. 3 illustrates an example of an entire screen of a URL 1 page;

FIG. 4A illustrates a screen example of a notable part;

FIG. 4B illustrates a screen example of a notable part;

FIG. 4C illustrates a screen example of a notable part;

FIG. 5A illustrates a screen example in which a following part subsequent to the notable part is further displayed;

FIG. 5B illustrates a screen example in which a following part subsequent to the notable part is further displayed;

FIG. 6 illustrates a screen example in which a previous part prior to the notable part is further displayed;

FIG. 7 illustrates a block diagram illustrating a hardware configuration and a functional configuration of a user terminal and a GW server according to Embodiment 1;

FIG. 8 illustrates a HTML description example of the URL 0 page;

FIG. 9 illustrates a HTML description example of the URL 1 page;

FIG. 10 illustrates an example of a list of keyword candidates and link destination candidate URLs of the URL 0 page;

FIG. 11 illustrates an example of a table indicating the association between tags and second scores;

FIG. 12 illustrates the importance of each of candidate portions (a) to (c);

FIG. 13 illustrates an example of division of the URL 1 page;

FIG. 14 illustrates an example of a table indicating the association between a text and an image of each part and a display priority thereof;

FIG. 15 illustrates calculation results of display priorities of texts and images of respective parts;

FIG. 16 illustrates an example of a response formed by a multi-part format.

FIG. 17 illustrates an example of a flow chart illustrating an overall flow of a display control process;

FIG. 18 illustrates an example (1) of a flow chart illustrating a flow of a keyword search process;

FIG. 19 illustrates an example (2) of a flow chart illustrating the flow of the keyword search process;

FIG. 20 illustrates an example of a flow chart illustrating a flow of a response generation process;

FIG. 21 illustrates a tree structure provided based on a HTML description of the URL 1 page;

FIG. 22 illustrates a HTML description example in which a notable part is supplemented by tags of parent elements;

FIG. 23 illustrates a network configuration diagram according to Variation 2 of the present invention;

FIG. 24 illustrates a block diagram illustrating a hardware configuration and a functional configuration of a user terminal according to Variation 2;

FIG. 25 illustrates a schematic diagram illustrating transition examples of Web pages;

FIG. 26 illustrates information of a search result page;

FIG. 27 illustrates information of the URL 0 page;

FIG. 28 illustrates information of a URL 08 page;

FIG. 29 illustrates information of a URL 10 page;

FIG. 30 illustrates an example of a list of NG words;

FIG. 31 illustrates an example of a flow chart illustrating a flow of a keyword candidate extraction process;

FIG. 32 illustrates examples of addition of jump marks to the URL 1 page;

FIG. 33 illustrates a screen example of the URL 1 page when the display control process is performed;

FIG. 34 illustrates an example of a flow chart illustrating a flow of a response generation process; and

FIG. 35 illustrates a description example of a process of each functional section.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

A user needs to further search for desired information in the next Web page displayed, even when the next Web page is displayed based on the selection of a block as described in Non-Patent Document 1. Further, as described above, various pieces of information are embedded in a Web page, and its structure is also increased in complexity and variety, and therefore, it is difficult to quickly acquire desired information from a Web page.

Therefore, an object of the present invention is to provide a technique for allowing desired information to be quickly acquired from a Web page.

<General Outline>

When a Web page acquired from a Web server is displayed, a user terminal displays the Web page from a notable part significantly relevant to information desired by a user. Display control methods for carrying out display in this manner include the following two methods. Display Control Method 1: A Web page subsequently displayed is divided into a notable part, and an accessory part serving as a part other than the notable part. First, the notable part is transmitted to the user terminal, and thereafter, the accessory part is transmitted to the user terminal. The user terminal initially displays the notable part that has been received first, and then displays the accessory part. The display control method 1 will be described in Embodiment 1.

Display Control Method 2: A jump mark is added to a notable part of a Web page subsequently displayed, and a command for a jump to the jump mark is generated. Upon reception of the Web page to which the jump mark is added and the jump command, the user terminal displays the Web page from the notable part to which the jump mark is added in accordance with the jump command. The display control method 2 will be described in Embodiment 2.

### Embodiment 1

(1) Overall Configuration

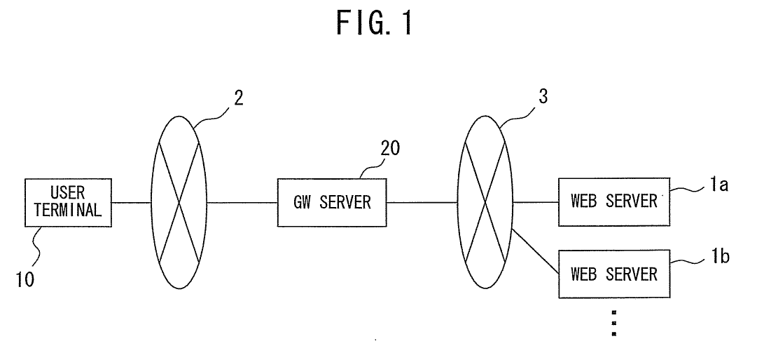

FIG. 1 illustrates a network configuration diagram according to Embodiment 1 of the present invention. A Web server 1 (1a, 1b . . . ) and a user terminal 10 are connected via networks 2 and 3, and a GW (Gate Way) server 20. The Web server refers to a server for accumulating information including texts, images and music, and for providing these pieces of information in response to a request. The information is formed in chunks, such as Web pages, for example, which are displayed by the user terminal. The GW server refers to a server for connecting communication between different networks, and functions as a relay device for performing relay between the user terminal 10 and the Web server 1 in the present embodiment. The user terminal is a browser terminal, such as a Web browser, for example, on which application software for browsing a Web page is installed.

When the user terminal 10 has received a request for access to a desired Web page from a user, the GW server 20 acquires the desired Web page from the Web server 1 and transmits the desired Web page to the user terminal 10 in response to the access request. Due to the execution of a display control process by the GW server 20 and the user terminal 10, the user terminal 10 displays the Web page from a notable part significantly relevant to information desired by the user.

(2) General Outline of Display Control Process

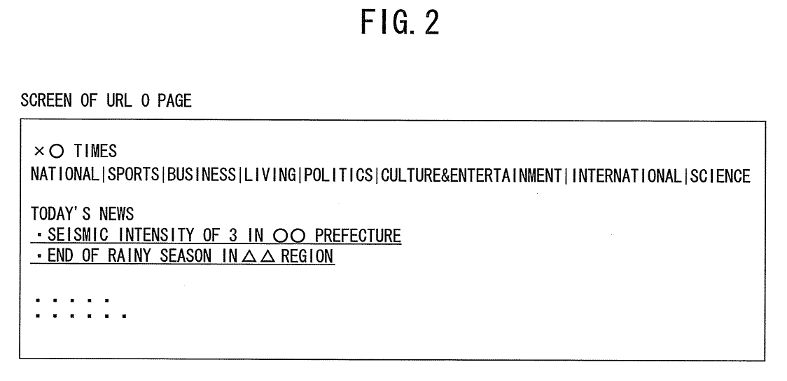

With reference to FIGS. 2 to 6, the general outline of the display control process according to Embodiment 1 will be described. The description will be made about a case where switching is performed from a URL (Uniform Resource Locator) 0 page, which is a Web page, to a URL 1 page, which is the next Web page. Hereinafter, the description will be made using an example in which the URL 0 page is displayed based on a search keyword “×◯TIMES”, and the URL 1 page is displayed based on the selection of a link of “SEISMIC INTENSITY OF 3 IN ◯◯ PREFECTURE”.

FIG. 2 illustrates a screen example of the URL 0 page. The user terminal 10 receives the search keyword “×◯TIMES” from the user, and displays the URL 0 page. It should be noted that the URL of the URL 0 page is “example.com”. In the URL 0 page, links to a plurality of link destination Web pages are embedded. In FIG. 2, links of “SEISMIC INTENSITY OF 3 IN ◯◯ PREFECTURE”, “END OF RAINY SEASON IN ΔΔ REGION”, etc. are embedded. The user terminal 10 receives the selection of a link of “SEISMIC INTENSITY OF 3 IN ◯◯ PREFECTURE” from the user, and displays the URL 1 page as the next Web page based on this selection.

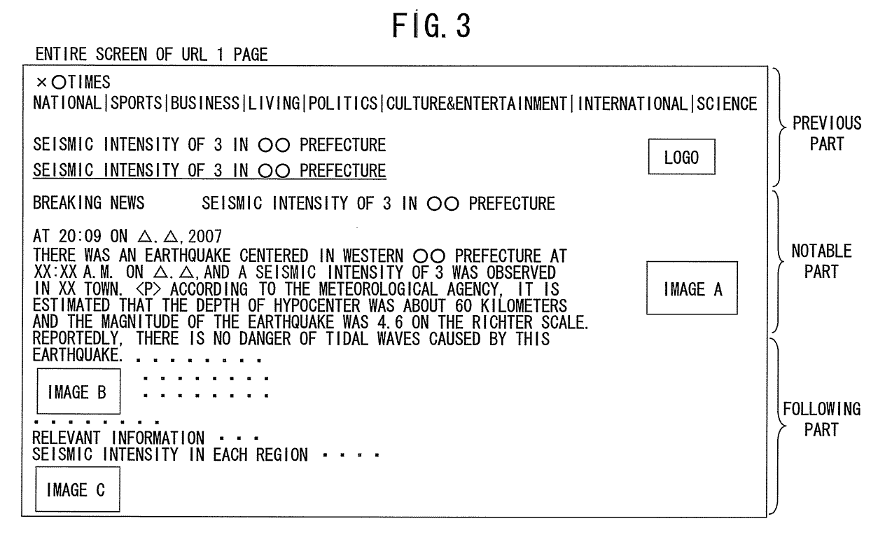

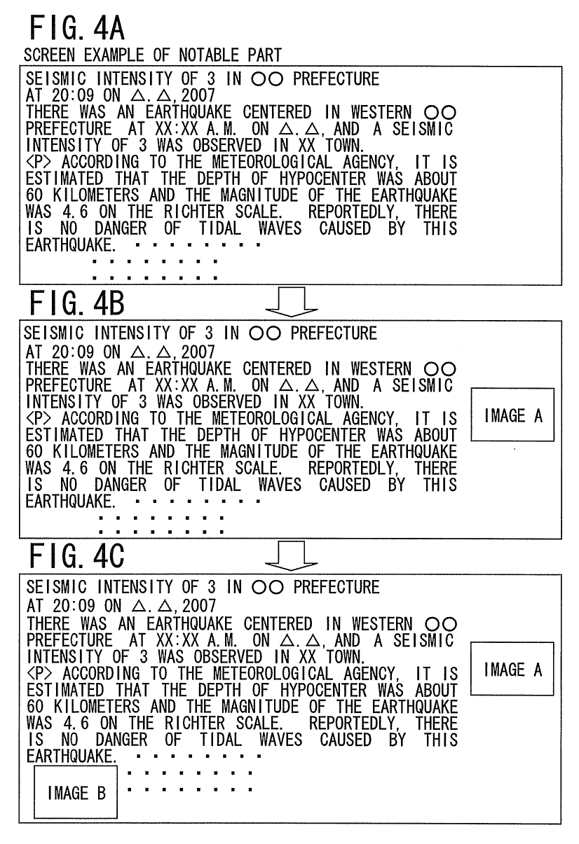

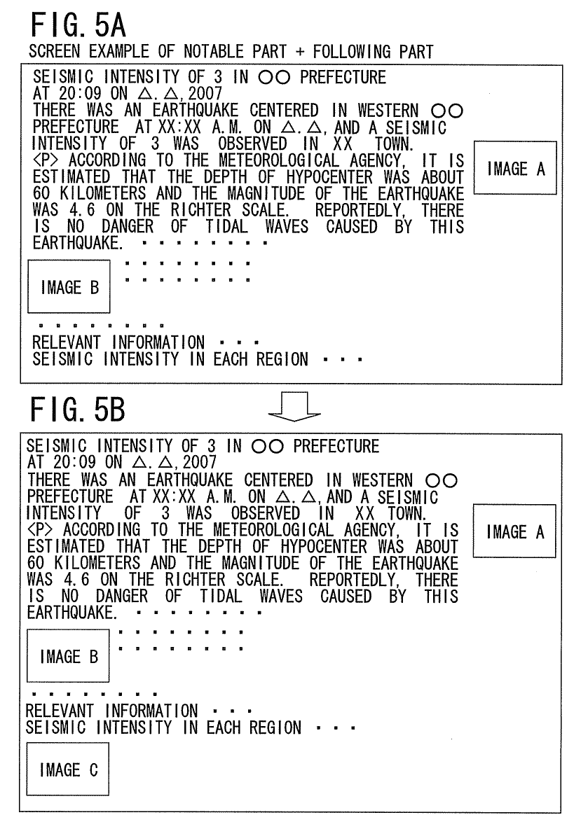

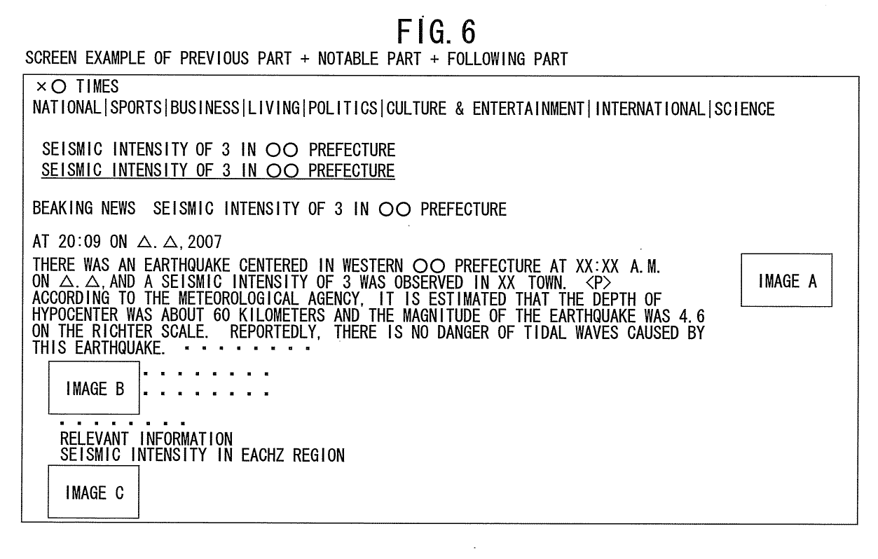

FIG. 3 illustrates an example of an entire screen of the URL 1 page. FIGS. 4 to 6 illustrate a flow of display of the URL 1 page when the display control process is performed. FIG. 4 illustrates a screen example of a notable part, FIG. 5 illustrates a screen example in which a following part subsequent to the notable part is further displayed, and FIG. 6 illustrates a screen example in which a previous part prior to the notable part is further displayed. Due to the selection of a link of “SEISMIC INTENSITY OF 3 IN ◯◯ PREFECTURE”, the user terminal 10 receives, from the user, a request for access to the URL 1 page linked to “SEISMIC INTENSITY OF 3 IN ◯◯ PREFECTURE”. The GW server 20 receives the access request from the user terminal 10, and acquires the URL 1 page from the Web server 1 based on the access request. The GW server 20 extracts, as a keyword relevant to the URL 1 page, a link character string used in the link to the URL 1 page from the URL 0 page. In this embodiment, the link character string is “SEISMIC INTENSITY OF 3 IN ◯◯ PREFECTURE”.

Next, the GW server 20 searches the URL 1 page based on the extracted keyword “SEISMIC INTENSITY OF 3 IN ◯◯ PREFECTURE”, and detects a notable portion. When a plurality of notable portions are detected, the importance of each notable portion is calculated to decide the portion having the highest importance as the notable portion. As depicted in FIG. 3, the GW server 20 divides the URL 1 page into: a notable part including a notable portion; a following part appearing after the notable part; and a previous part appearing before the notable part. Furthermore, a text and an image of each part are separated from each other. Moreover, the display priorities of the text and image of each part are decided, and the text and image of each part are transmitted to the user terminal 10 in descending order of display priorities.

For example, the display priorities are decided in the following descending order: the text of the notable part, an image A of the notable part, an image B of the notable part, the text of the following part, an image C of the following part, the text of the previous part, and the image logo of the previous part. The user terminal 10 receives the respective parts in descending order of display priorities, and displays the respective parts as depicted in FIGS. 4 to 6. First, as depicted in FIG. 4A to 4C, the text of the notable part is displayed (see FIG. 4A). The image A is then displayed so as to be added to the text (see FIG. 4B). The image B is further additionally displayed (see FIG. 4C).

Next, as depicted in FIGS. 5A and 5B, the text of the following part is displayed in addition to the notable part (see FIG. 5A), and the image C is further displayed (see FIG. 5B). Next, as depicted in FIG. 6, the text of the previous part is displayed in addition to the notable part and the following part, and the image logo of the previous part is finally displayed as depicted in FIG. 3.

(3) Internal Configuration

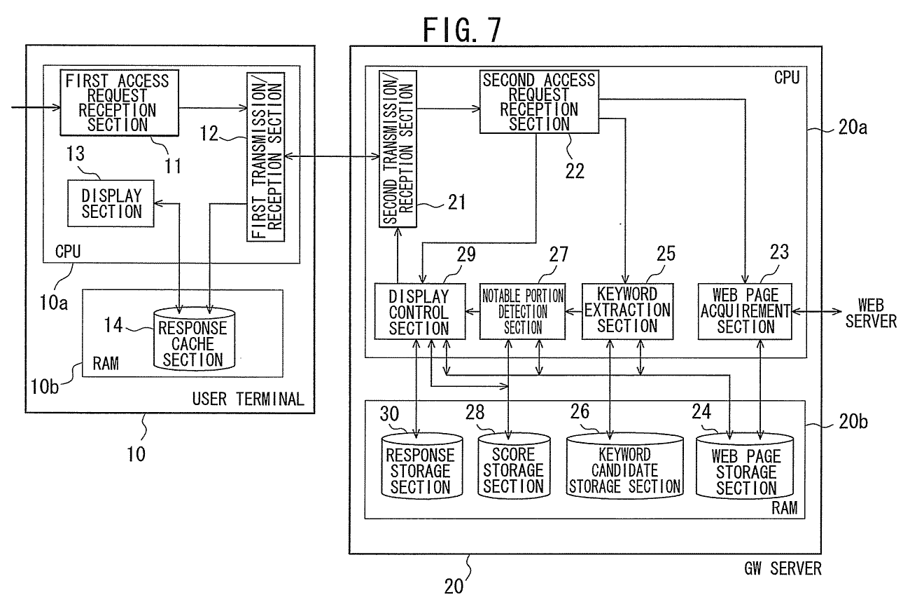

FIG. 7 illustrates a block diagram illustrating a hardware configuration and a functional configuration of the user terminal and the GW server according to Embodiment 1. The user terminal 10 includes, for example, a CPU (Central Processing Unit) 10a, a RAM (Random Access Memory) 10b, an undepicted ROM (Read-Only Memory), etc. The GW server 20 also includes a CPU 20a, a RAM 20b, an undepicted ROM, etc. Hereinafter, the functional configuration of the user terminal 10 and the GW server 20 for performing the display control process will be described.

(3-1) Functional Configuration of User Terminal

(i) First Access Request Receptor

A first access request receptor 11 of the CPU 10a receives a request for access to Web pages such as the URL 0 page and the URL 1 page from the user of the user terminal 10. The first access request receptor 11 first receives a request for access to the URL 0 page from the user. For example, the user inputs a search keyword or a URL relevant to information, which is desired to be obtained, to a search screen displayed on the user terminal 10, and selects a link set to a given Web page displayed on the user terminal 10. Thus, the first access request receptor 11 receives the request for access to the URL 0 page, and transmits the access request to the GW server 20 via a first transmitter/receptor 12 described later. In this embodiment, the request for access to the URL 0 page, which is transmitted to the GW server 20, includes the URL of the URL 0 page.

For example, the first access request receptor 11 receives the search keyword “×◯ TIMES” from the user. Based on this, the first access request receptor 11 transmits the access request, including “example.com” serving as the URL of the URL 0 page, to the GW server 20. Then, the first access request receptor 11 receives a request for access to the URL 1 page from the user, with the URL 0 page displayed by a display 13 described later. In the URL 0 page, links to one or a plurality of link destination Web pages are embedded, and the user selects the link to the desired URL 1 page from among the link destination Web pages. Thus, the first access request receptor 11 receives the request for access to the URL 1 page, and transmits the access request to the GW server 20. In this embodiment, the request for access to the URL 1 page, which is transmitted to the GW server 20, includes the URL of the URL 1 page.

For example, the first access request receptor 11 receives the selection of a link of “SEISMIC INTENSITY OF 3 IN ◯◯ PREFECTURE” within the URL 0 page from the user. Based on this, the first access request receptor 11 transmits the access request, including “example.com/070920031.html” serving as the URL of the URL 1 page, to the GW server 20.

(ii) First Transmission/Receptor

The first transmitter/receptor 12 of the CPU 10a serves as an interface for the user terminal 10, and communicates with the GW server 20. For example, the first transmitter/receptor 12 transmits the access request to the GW server 20, and receives a response from the GW server 20.

(iii) Response Cache, and Display

A response cache 14 of the RAM 10b receives a response to the access request from the first transmitter/receptor 12, and temporarily stores the response. The display 13 acquires the response from the response cache 14, and displays a Web page.

(3-2) Functional Configuration of GW Server

(i) Second Access Request Receptor, and Second Transmitter/Receptor

A second transmitter/receptor 21 of the CPU 20a serves as an interface for the GW server 20, and communicates with the user terminal 10 by receiving the access request from the user terminal 10, and transmitting the response to the user terminal 10, for example.

A second access request receptor 22 of the CPU 20a receives the request for access to the URL 0 page and URL 1 page from the user terminal 10, and transmits the access request to a Web page acquirer 23, a keyword extractor 25 and a display controller 29 which are described later.

(ii) Web Page Acquirer, and Web Page Storage

The Web page acquirer 23 of the CPU 20a acquires a Web page from the Web server 1 based on the URL included in the access request.

For example, the Web page acquirer 23 receives the access request, including “example.com” serving as the URL of the URL 0 page, from the second access request receptor 22, and acquires the URL 0 page from the Web server 1 based on this. Further, the Web page acquirer 23 receives the access request, including “example.com/070920031.html” serving as the URL of the URL 1 page, from the second access request receptor 22, and acquires the URL 1 page from the Web server 1 based on this.

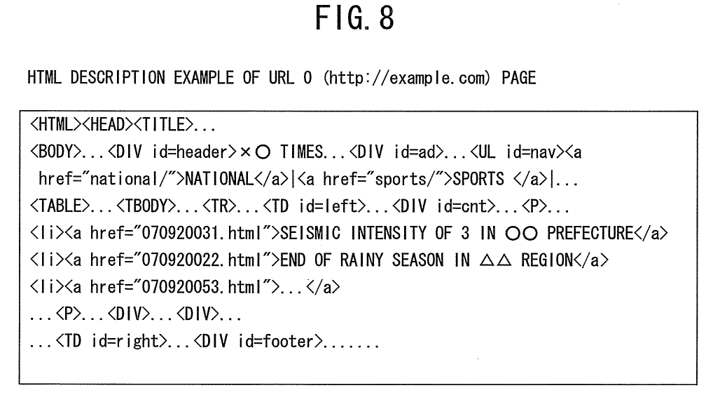

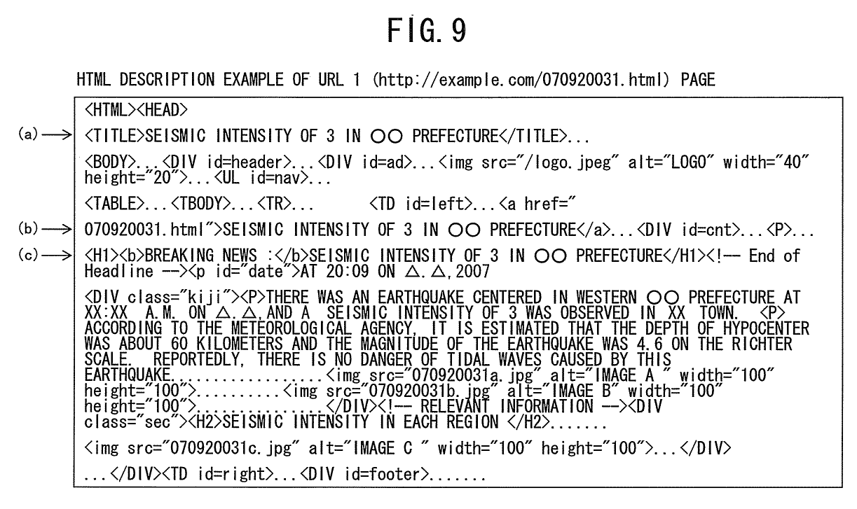

A Web page storage 24 of the RAM 20b stores these Web pages. FIGS. 8 and 9 illustrate HTML (Hyper Text Markup Language) description examples of the Web pages stored in the Web page storage 24. FIG. 8 illustrates a HTML description example of the URL 0 page, and FIG. 9 illustrates a HTML description example of the URL 1 page.

(iii) Keyword Extractor, and Keyword Candidate Storage

The keyword extractor 25 of the CPU 20a receives the request for access to the URL 1 page from the second access request receptor 22, and extracts, from the URL 0 page, a keyword relevant to the URL 1 page based on the access request.

The request for access to the URL 1 page includes “example.com/070920031.html” serving as the URL of the URL 1 page. Furthermore, the keyword relevant to the URL 1 page refers to a keyword relevant to information, which the user wishes to obtain from the URL 1.

First, the keyword extractor 25 extracts a keyword candidate from the URL 0 page stored in the Web page storage 24. The keyword candidate is a keyword that can be a keyword relevant to the next URL 1 page, and is a link character string to which a link is set in the URL 0 page, for example. The link is, for example, set by sandwiching the link character string between a set of link tags <a href=“”> and </a>. The keyword extractor 25 searches the URL 0 page for the link tags, and extracts, as the keyword candidate, the link character string sandwiched between the link tags. Moreover, the keyword extractor 25 acquires a link destination candidate URL associated with the keyword candidate. It should be noted that if a plurality of the keyword candidates exist for the single link destination candidate URL, the keyword extractor 25 extracts all the keyword candidates.

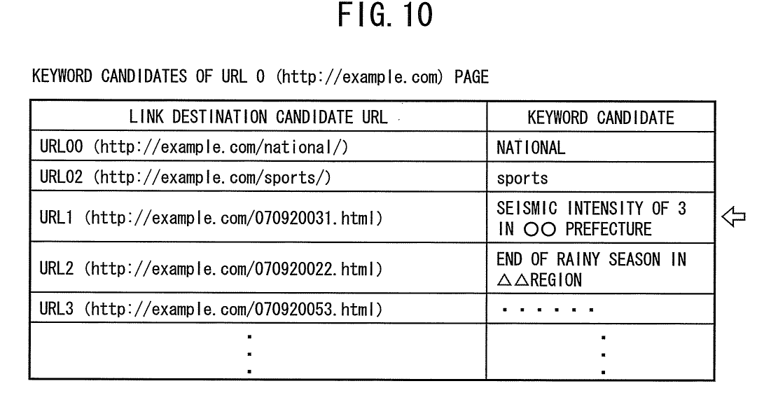

A keyword candidate storage 26 stores the extracted keyword candidate and link destination candidate URL. FIG. 10 illustrates an example of a list of keyword candidates and link destination candidate URLs of the URL 0 page. For example, in the HTML description example depicted in FIG. 8, a link is set to a character string “NATIONAL”, and the file name of the link destination is “/national/”. Hence, the keyword candidate storage 26 stores “NATIONAL” and “example.com/national/” in association with each other as the keyword candidate and the link destination candidate URL, respectively. In this embodiment, a list of keyword candidates for only the URL 0 page is depicted, but a list of keyword candidates like this is created for each URL page.

Next, the keyword extractor 25 searches the keyword candidate list of the URL 0 page for the link destination candidate URL corresponding to the URL of the URL 1 page included in the access request. The keyword extractor 25 extracts, as the keyword relevant to the URL 1 page, the keyword candidate associated with the relevant link destination candidate URL. For example, the keyword extractor 25 acquires, from the access request, “example.com/070920031.html” serving as the URL of the URL 1 page, and searches the list depicted in FIG. 10 for the link destination candidate URL corresponding to this URL. Then, “SEISMIC INTENSITY OF 3 IN ◯◯ PREFECTURE” is extracted as the keyword relevant to the URL 1 page.

It should be noted that although the keyword candidate is extracted based on the link character string, the keyword candidate is not limited to the link character string, and a character string prior to or subsequent to the link character string, for example, may be extracted as the keyword candidate. By extracting a keyword and displaying a Web page from a portion corresponding to the keyword as described above, information desired by the user can be preferentially displayed. In other words, the user selects desired information based on a link character string to which a link within the URL 0 page is set, and selects the next URL 1 page. Hence, in the link character string used as the link to the URL 1 page, a keyword relevant to the information desired by the user is represented. Therefore, the information desired by the user can be preferentially displayed by extracting the above-described link character string as the keyword relevant to the URL 1 page.

(iv) Notable Portion Detector, and Score Storage

A notable portion detector 27 of the CPU 20a acquires the keyword relevant to the URL 1 page from the keyword extractor 25. Further, the notable portion detector 27 detects a notable portion relevant to the keyword within the URL 1 page stored in the Web page storage 24. The notable portion relevant to the keyword refers to a portion in which a character string corresponding to the keyword is described. In addition, a portion in which character strings such as a synonym and a synonymous term of the keyword are described, for example, may be detected as the notable portion. Hence, the RAM 20b may have a storage for storing the synonym and synonymous term, the notable portion detector 27 may acquire the synonym and synonymous term associated with the keyword from the storage, and the notable portion may be detected based on the acquired synonym and synonymous term.

Further, when a plurality of candidate portions relevant to the keyword are detected, the importance of each candidate portion is calculated to detect the candidate portion having the highest importance as the notable portion. For example, the notable portion detector 27 receives “SEISMIC INTENSITY OF 3 IN ◯◯ PREFECTURE” as a keyword from the keyword extractor 25, and searches the URL 1 page based on the keyword. From the description example of the URL 1 page depicted in FIG. 9, keywords are detected in three candidate portions (a) to (c). The importance of each candidate portion is calculated as follows, for example.

The notable portion detector 27 calculates the importance of each candidate portion on the basis of, for example, a first score based on a keyword length, a second score based on the type of tags sandwiching the keyword, and a third score based on the number of characters that are continuous after the keyword. For example, the first score is calculated by multiplying one character of the keyword by 17.5. Hence, the first score is calculated as 700 since the number of characters of “SEISMIC INTENSITY OF 3 IN ◯◯ PREFECTURE” is 40. Furthermore, in a score storage 28, a table indicating the association between tags and second scores is stored.

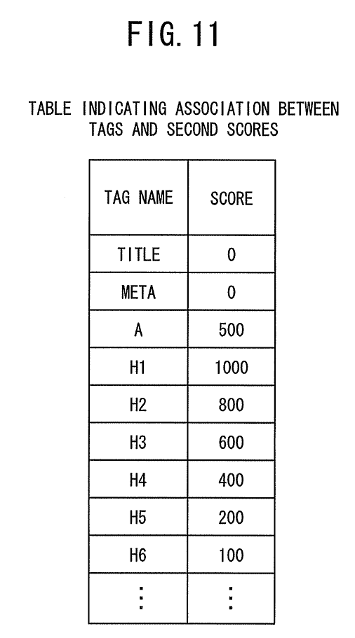

FIG. 11 illustrates an example of the table indicating the association between the tags and second scores. For example, the second scores are set to be low for tags such as a TITLE tag and a META tag, and the second scores are set in decreasing order for tags H1 to H6. Furthermore, when the number of characters continuous after the keyword is equal to or greater than a given value B, the third score is 1000. The given value B is 10 characters, for example.

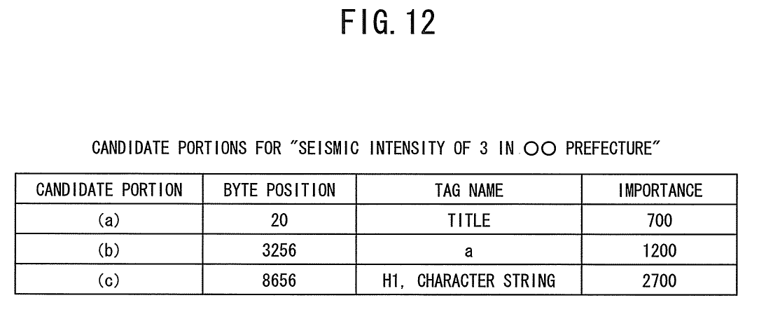

FIG. 12 illustrates the importance of each of the candidate portions (a) to (c). In the candidate portion (a), the second score is 0 since the tags sandwiching the keyword are TITLE tags, and the third score is 0 since no character is continuous after the keyword. Hence, the importance of the candidate portion (a) is 700, which corresponds to the first score. Further, since the tag of the candidate portion (b) is an A tag and no character is continuous after the keyword, the importance of the candidate portion (b) is 1200, resulting from the following expression: first score (700)+second score (500). Furthermore, since the tag of the candidate portion (c) is an H1 tag and ten or more characters are continuous after the keyword, the importance of the candidate portion (c) is 2700, resulting from the following expression: first score (700)+second score (1000)+third score (1000).

Thus, the notable portion detector 27 decides the candidate portion (c) having the highest importance as the notable portion. By deciding the candidate portion having the highest importance as the notable portion in this manner, the information that is most desired by the user is quickly displayed. It should be noted that it is sufficient to detect the notable portion, and the importance calculation method is not limited to the foregoing method. Besides, when the name of a jump destination is provided in the URL of the URL 1 page so as to be continuous with an anchor such as “#”, for example, the keyword extractor 25 transmits the jump destination to the notable portion detector 27.

The notable portion detector 27 detects this jump destination as the notable portion. For example, when the URL of the URL 1 page is “example.com/070920031.html#cnt”, the portion of “<a name=“cnt”>” within the URL 1 page, or the portion of an element in which an id (identifier) property is “cnt” becomes the notable portion.

Furthermore, when the portion relevant to keyword is not detected, the notable portion detector 27 further searches the URL 1 page by decomposing the keyword, and/or replacing the keyword with another keyword, for example. For example, when the keyword is “SEISMIC INTENSITY OF 3 IN ◯◯ PREFECTURE”, “SEISMIC INTENSITY OF 3 IN ◯◯ PREFECTURE” is decomposed into words such as “Seismic Intensity of 3” and “◯◯ PREFECTURE”. Further, reference may be made to the storage for storing synonyms, synonymous terms, etc., and the words may be replaced with other keywords such as “EARTHQUAKE” and “MAGNITUDE”. If the keyword is decomposed, the relevance of the decomposed keyword to the URL 1 page might be lower than that of the keyword prior to decomposition to the URL 1 page, and therefore, the importance may be calculated by subtracting a given score C therefrom.

Furthermore, when the number of portions relevant to the keyword is larger than a given value A, the notable portion detector 27 may regard the keyword as a general word so as not to determine the detected portions as the notable portions. Moreover, when the importance of a candidate portion is lower than a given value D, the notable portion detector 27 may determine that the relevance of this portion to the URL 1 page is low and exclude this portion from the candidate portions.

(v) Display Controller

Upon reception of a request for access to a Web page from the second access request receptor 22, the display controller 29 of the CPU 20a first searches a response storage 30, which will be described later, to find out whether a response to the access request is stored. If the response is stored, the Web page is acquired as the response from the response storage 30, and the response is transmitted to the user terminal 10 via the second transmitter/receptor 21. If the response is not stored, the Web page is acquired from the Web page storage 24, and the response is generated and transmitted to the user terminal 10. Hereinafter, a method for generating a response to a request for access to the URL 1 page will be described.

The display controller 29 acquires the URL 1 page from the Web page storage 24, acquires the notable portion detected by the notable portion detector 27, and identifies the notable part including the notable portion. Specifically, the display controller 29 identifies, as the notable part, a part whose starting point is the notable portion and whose end point is located at a position up to a given number of bytes, for example, in the URL 1 page. Alternatively, a part ranging from a tag located immediately before the above-mentioned starting point to a tag located immediately after the above-mentioned end point may be identified as the notable part.

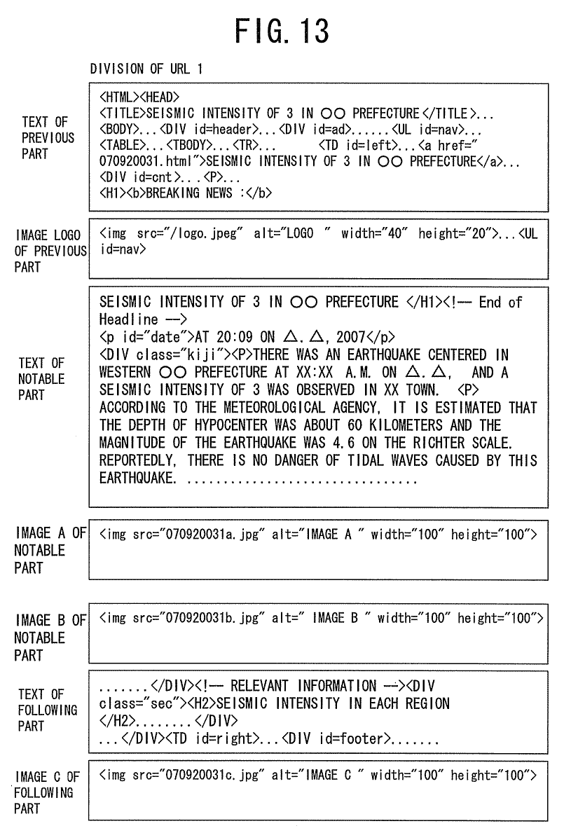

Next, the display controller 29 divides the URL 1 page into a notable part, a following part appearing after the notable part, and a previous part appearing before the notable part, for example. Besides, a text and an image are separated from each other in each part. FIG. 13 illustrates an example of division of the URL 1 page. Based on the notable portion, the URL 1 page depicted in FIG. 9 is divided into: a text of the previous part; an image logo of the previous part; a text of the notable part; an image A of the notable part; an image B of the notable part; a text of the following part; and an image C of the following part. It should be noted that, in addition to the separation of the text and image, the Web page may be separated in accordance with types of information such as text, image and music.

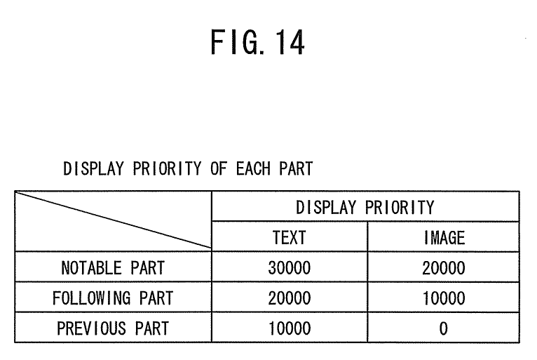

Moreover, the display controller 29 decides the display priorities of the respective divided parts. The display priorities serve as values indicating the priorities of display for texts, images, etc. in the user terminal. In this case, the display priority of the notable part is set to be higher than that of an accessory part which is a part other than the notable part, and the display priority of the following part is set to be higher than that of the previous part. In this embodiment, the score storage 28 stores a table indicating the association between the text and image of each part and the display priorities thereof. FIG. 14 illustrates an example of the table indicating the association between the text and image of each part and the display priorities thereof. For example, if attention is focused on the texts, the score of the notable part is set at the highest value, and the score of the following part is set to be higher than that of the previous part. Further, in each part, the score of the text is set to be higher than that of the image.

Moreover, as for each image, an addition is performed on the display priority based on the distance between the notable portion and image, the number of bytes of the image, the display size, the number of times of appearance, the directory relationship between the URL at which the image is stored and the URL of the second Web page, whether or not a link is set to the image, etc. Hereinafter, each specific example will be described.

(Distance Between Notable Portion and Image)

If the number of bytes of the entire URL 1 page is defined as “S”, the byte position of the notable portion is defined as “r”, and the byte position of the image is defined as “in”, the added display priority will be expressed as follows:

(1−|r−in|/S)×k.

In this expression, “k” represents a coefficient, and is 5000, for example, which is smaller than the display priority of the text by, for example, an order of magnitude. Thus, the closer the image to the notable portion, the higher the display priority is set.

(Number of Bytes of Image)

Among the numbers of bytes of the respective images of the URL 1 page, if the maximum number of bytes is defined as “bn_max” and the number of bytes of the target image is defined as “bn”, the added display priority will be expressed as follows:

(1−bn/bn_max)×j.

In this expression, “j” represents a coefficient, and is 100, for example, which is smaller than “k” by, for example, an order of magnitude. Thus, the smaller the number of bytes of the image, the higher the display priority is set. When the number of bytes of the image is small, the time required for display is short, and therefore, only a slight influence is exerted even if the display priority is high.

(Display Region)

Among display regions of the respective images of the URL 1 page, if the maximum display region is defined as “cn_max” and the display region of the target image is defined as “cn”, the added display priority will be expressed as follows:

cn/cn_max×h.

In this expression, “h” represents a coefficient, and is 100, for example, which is smaller than “k” by, for example, an order of magnitude. Thus, the greater the display region, the higher the display priority is set.

(Number of Times of Appearance)

Among the numbers of times of appearance of the respective images of the URL 1 page, if the maximum number of times of appearance is defined as “an_max” and the number of times of appearance of the target image is defined as “an”, the added display priority will be expressed as follows:

(1−an/an_max)×i.

In this expression, “i” represents a coefficient, and is 100, for example, which is smaller than “k” by, for example, an order of magnitude. Thus, if the number of times of appearance is large, there is a high possibility that the image is an ornament for decorating the Web page; therefore, the larger the number of times of appearance, the lower the display priority is set.

(Directory Relationship)

For example, when the URL of the image is in the same directory as the URL of the second Web page, or in a subdirectory thereof, the display priority is set to be higher than the case where the directories are different.

(Setting of Link to Image)

Further, when a link is set to the image, there is a high possibility that this link serves as a link to a more detailed image, and a given score is added to the display priority.

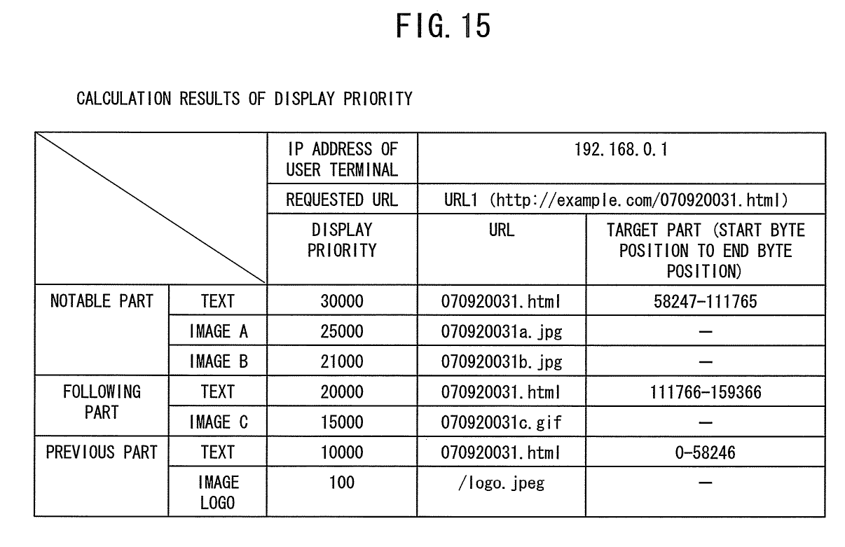

Based on the association table depicted in FIG. 14 and the foregoing image display priority calculation method, etc., the display controller 29 calculates the display priorities of the texts and images of the respective parts depicted in FIG. 13. FIG. 15 illustrates calculation results of display priorities of texts and images of the respective parts. In FIG. 15, there are depicted, for example, the IP address of the user terminal, the URL of the URL 1 page which has been requested, the display priorities of the respective parts, the URLs of the respective parts, the byte positions in the URL 1 page, etc.

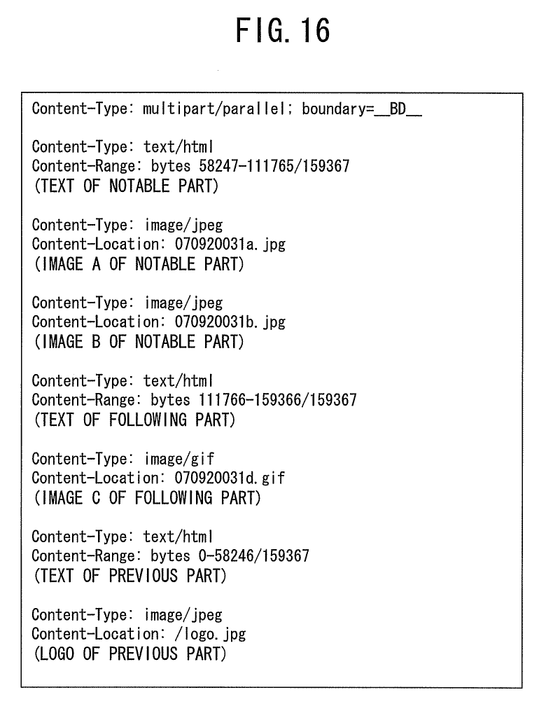

The display controller 29 makes reference to the calculation results depicted in FIG. 15, and transmits the respective parts to the user terminal 10 via the second transmitter/receptor 21 in descending order of display priorities. At this time, the display controller 29 generates a response by forming the respective parts by a multi-part format so that the respective parts can be sequentially transmitted. FIG. 16 illustrates an example of a response formed by a multi-part format. The second transmitter/receptor 21 receives the response from the display controller 29, and transmits the response to the user terminal 10.

Thus, the notable part is first displayed on the user terminal 10, and the user can quickly acquire the desired information. In this embodiment, there is a high possibility that the contents concerning the notable part are provided subsequently thereto, including the case where the notable part is followed by the contents thereof. By sequentially displaying the following part and the previous part subsequently to the notable part, the user can rapidly acquire information of the highly relevant following part following the notable part.

Further, in general, the number of bytes of an image is larger than that of a text, and the time required for display of an image is longer than the time required for display of a text. Therefore, the display priority of the text is set to be higher than that of the image, thereby displaying the text having a relatively small number of bytes before the image. Thus, the desired information can be more rapidly displayed.

(vi) Response Storage

The response storage 30 stores the response generated by the display controller 29.

(4) Process Flow

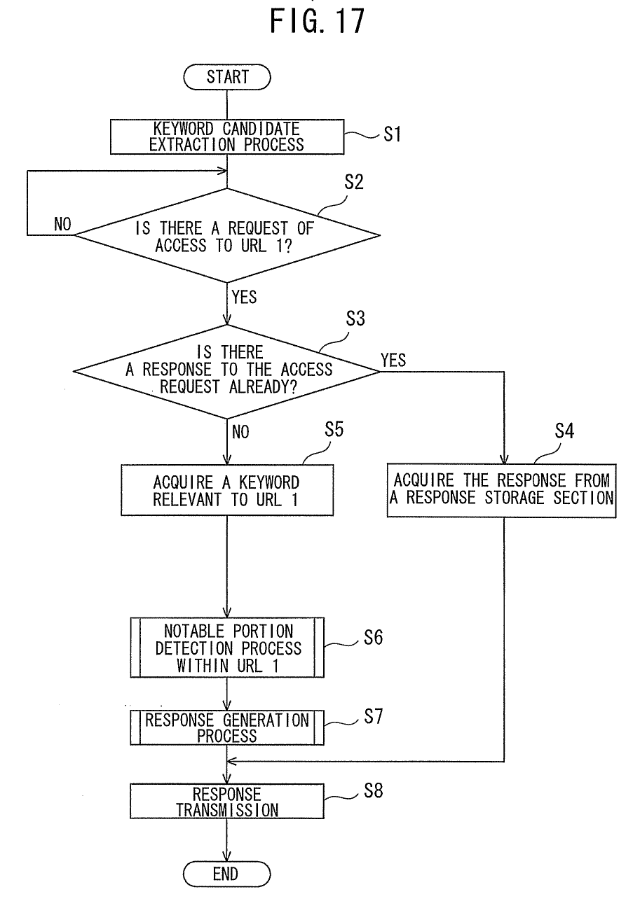

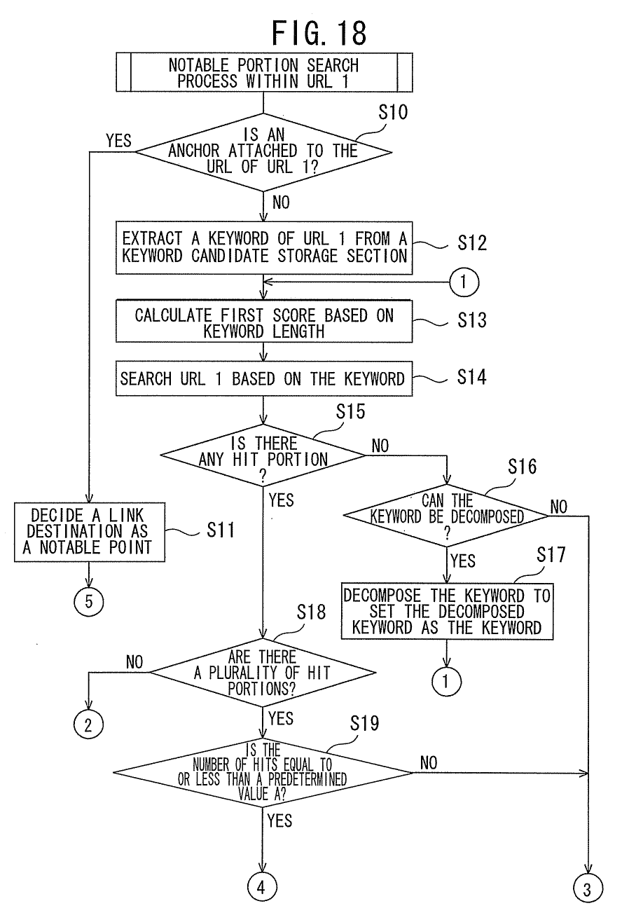

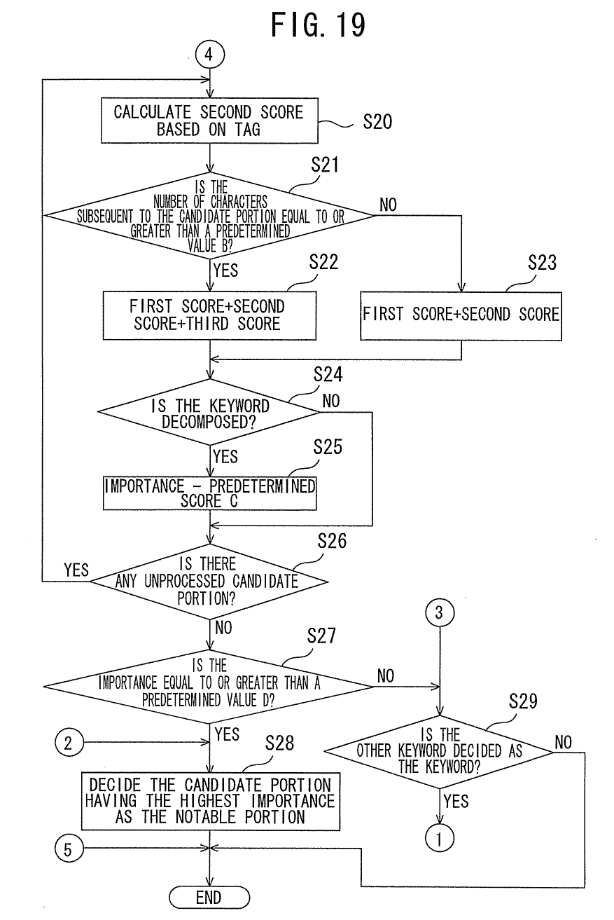

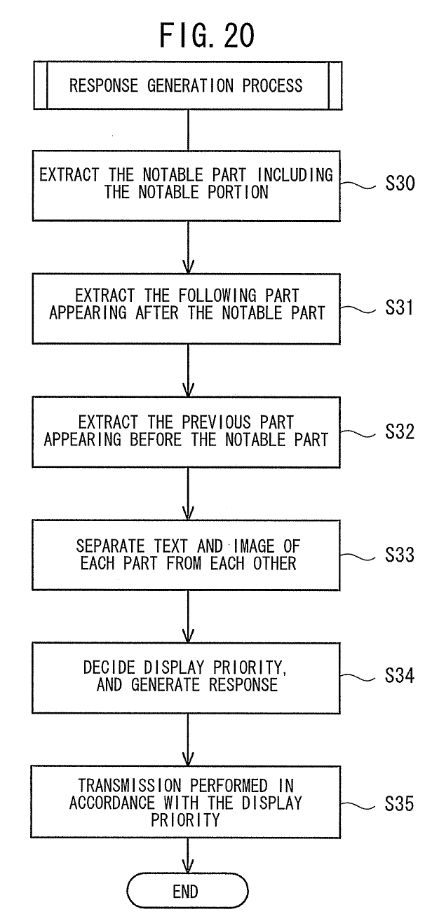

Next, an overall flow of the display control process will be described with reference to FIGS. 17 to 20. FIG. 17 illustrates an example of a flow chart illustrating the overall flow of the display control process, FIGS. 18 and 19 each illustrate an example of a flow chart illustrating a flow of a keyword search process, and FIG. 20 illustrates an example of a flow chart illustrating a flow of a response generation process.

(4-1) Overall Display Control Process

Referring to FIG. 17, the overall flow of the display control process will be described. The user terminal 10 receives, for example, a search keyword from the user, and displays the URL 0 page. At this time, the Web page storage 24 stores the URL 0 page, which is acquired by the Web page acquirer 23 from the Web server 1. Next, when the URL 1 page is to be displayed based on the selection of a link set within the URL 0 page, the following operations are performed.

Operation S1: The keyword extractor 25 extracts a keyword candidate and a link destination candidate URL from the URL 0 page. The keyword candidate storage 26 stores the extracted keyword candidate and link destination candidate URL. Operation S2: Upon reception of a request for access to the URL 1 page by the second access request receptor 22, the process proceeds to Operation S3, but the process is put on standby if there is no access request.

Operation S3: The display controller 29 receives the request for access to the URL 1 page from the second access request receptor 22. The access request includes the URL of the URL 1 page. The display controller 29 searches the response storage 30 to find out whether a response to the access request is stored, and the process proceeds to Operation S4 if the response is stored. If the response is not stored, the process proceeds to Operation S5.

Operation S4: The display controller 29 acquires the URL 1 page as the response from the response storage 30, and transmits the response to the user terminal 10 in accordance with the display priority.

Operation S5: The keyword extractor 25 receives the access request including the URL of the URL 1 page from the second access request receptor 22. The keyword extractor 25 searches for the link destination candidate URL corresponding to the URL of the URL 1 page, and extracts, as a keyword relevant to the URL 1 page, a keyword candidate associated with the relevant link destination candidate URL.

Operation S6: The notable portion detector 27 performs a notable portion detection process for detecting a notable portion within the URL 1 page.

Operation S7: The display controller 29 sets the display priority of a notable part to be higher than that of an accessory part, and performs a response generation process for generating a response to the request for access to the URL 1 page.

Operation S8: The second transmitter/receptor 21 receives the response from the display controller 29, and transmits the response to the user terminal 10.

(4-2) Notable Portion Detection Process

Referring to FIGS. 18 and 19, the notable portion detection process performed in Operation S6 will be described.

Operation S10: The keyword extractor 25 determines whether or not an anchor such as “#” is attached to the URL of the URL 1 page. When an anchor is attached, the process proceeds to Operation S11, and when no anchor is attached, the process proceeds to Operation S12.

Operation S11: The keyword extractor 25 transmits a jump destination, which is provided subsequently to the anchor, to the notable portion detector 27. The notable portion detector 27 detects this jump destination as the notable portion.

Operation S12: The keyword extractor 25 searches a list of keyword candidates in the URL 0 page for the link destination candidate URL corresponding to the URL of the URL 1 page. The keyword candidate of the relevant portion is extracted as the keyword relevant to the URL 1 page.

Operation S13: The notable portion detector 27 acquires the keyword from the keyword extractor 25, and calculates the first score based on the keyword length.

Operation S14: The notable portion detector 27 searches the URL 1 page based on the keyword relevant to the URL 1 page, thereby detecting the notable portion.

Operation S15: The process proceeds to Operation S16 when there is no hit portion, and the process proceeds to Operation S18 when there is a hit portion.

Operation S16: The notable portion detector 27 determines whether the keyword can be decomposed. When the keyword can be decomposed, the process proceeds to Operation S17, and when the keyword cannot be decomposed, the process proceeds to Operation S29.

Operation S17: The notable portion detector 27 decomposes the keyword to set the decomposed keyword as the next keyword, and the process returns to Operation S13.

Operation S18: When there are a plurality of hit portions, the process proceeds to Operation S19, and when there is one hit portion, the process proceeds to Operation S28.

Operation S19: The notable portion detector 27 determines whether or not the number of hits is equal to or less than the given value A. When the number of hits is equal to or less than the given value A, the process proceeds to Operation S20. When the number of hits is greater than the given value A, the process proceeds to Operation S29.

Operation S20: Next, the notable portion detector 27 decides the notable portion from among a plurality of hit portions, i.e., a plurality of candidate portions. The notable portion detector 27 calculates the second score in accordance with the type of tags sandwiching the keyword of each candidate portion.

Operation S21: The notable portion detector 27 determines whether the number of characters subsequent to the candidate portion, i.e., the number of characters continuous after the keyword, is equal to or greater than the given value B. When it is equal to or greater than the given value B, the process proceeds to Operation S22, and when it is less than the given value B, the process proceeds to Operation S23.

Operation S22: The notable portion detector 27 adds the third score to the importance when the number of characters after the keyword is equal to or greater than the given value B. Hence, the importance is calculated by the following expression: first score+second score+third score.

Operation S23: When the number of characters after the keyword is less than the given value B, the importance is calculated by the following expression: first score+second score.

Operations S24 and S25: When the keyword has been decomposed, the notable portion detector 27 subtracts the given score C from the importance.

Operation S26: The notable portion detector 27 returns the process to Operation S20 to calculate the importance if there is any unprocessed candidate portion. If there is no unprocessed candidate portion, the process proceeds to Operation S27.

Operation S27: The notable portion detector 27 extracts only the candidate portions whose importance is equal to or greater than the given value D, and the process proceeds to Operation S28. When the importance of each of all the candidate portions is less than the given value D, the process proceeds to Operation S29.

Operation S28: The notable portion detector 27 decides, among the candidate portions, the candidate portion having the highest importance as the notable portion.

Operation S29: Since no notable portion can be detected, the notable portion detector 27 returns the process to Operation S13 when the other keyword is decided as the keyword. In other cases, the process is ended.

(4-3) Response Generation Process

Next, the response generation process performed in Operation S7 will be described with reference to FIG. 20.

Operation S30: The display controller 29 identifies the notable part including the notable portion in the URL 1 page, and extracts the notable part.

Operations S31 and S32: The display controller 29 extracts the following part appearing after the notable part (S31), and further extracts the previous part appearing before the notable part (S32).

Operation S33: The display controller 29 separates the text and image of each part from each other.

Operation S34: The display controller 29 decides the display priority of each of the text and image of each part, and generates a response.

Operation S35: The second transmitter/receptor 21 transmits the response to the user terminal 10 in accordance with the display priority. It should be noted that the order of the respective process operations is not limited to the foregoing order, and Operations S31 and S32, for example, are in no particular order.

(5) Variation (5-1) Variation 1

The display controller 29 may extract a notable part as follows. The display controller 29 analyzes the HTML description of the URL 1 page, and first identifies an element including a notable portion. Moreover, the display controller 29 identifies a parent element of the element including the notable portion, and extracts sibling elements of the parent element in the order of appearance in the HTML description. In this embodiment, as the sibling elements, elements, which appear at positions posterior to the parent element of the element including the notable portion, are extracted. Furthermore, the display controller 29 extracts, as the notable part, a part sandwiched between a start-tag of the parent element of the element including the notable portion, and an end-tag of the sibling element whose appearance position is the last among the extracted sibling elements.

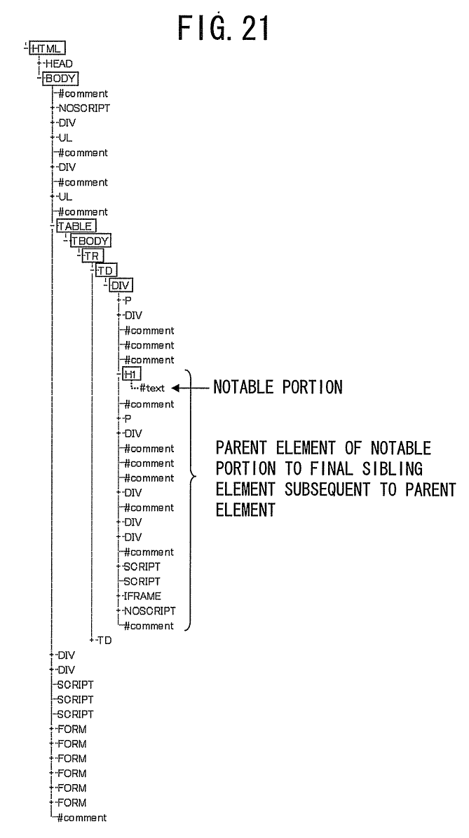

FIG. 21 illustrates a tree structure provided based on the HTML description of the URL 1 page. The display controller 29 extracts a “text” element depicted in FIG. 21 and including a notable portion. Further, the display controller 29 identifies a parent element for the notable portion, and extracts “H1” as a tag. Next, the display controller 29 identifies sibling elements whose appearance positions are posterior to that of the parent element, and extracts, as the elements, “comment”, “P”, “DIV”, . . . “IFRAME”, “NOSCRIPT”, and “comment” which are subsequent to “H1”. Finally, the display controller 29 extracts, as the notable part, a part ranging from <H1>, which is the start-tag of the parent element, to the end of the final sibling element.

Thus, the part, ranging from the parent element of the notable portion to the sibling element whose appearance position is the last among the sibling elements of the parent element, can be preferentially displayed as a chunk of the notable part. Hence, it is possible to prevent the display of the notable part from being interrupted in the midst of a text. Further, the display controller 29 sequentially extracts, starting from the element including the notable portion, parent elements whose appearance positions are anterior to that of the element of the notable portion in the order of appearance in the HTML description. At this time, the parent elements surrounded by frames in FIG. 21 are extracted. Next, the notable part is supplemented by start-tags of the respective parent elements in sequence.

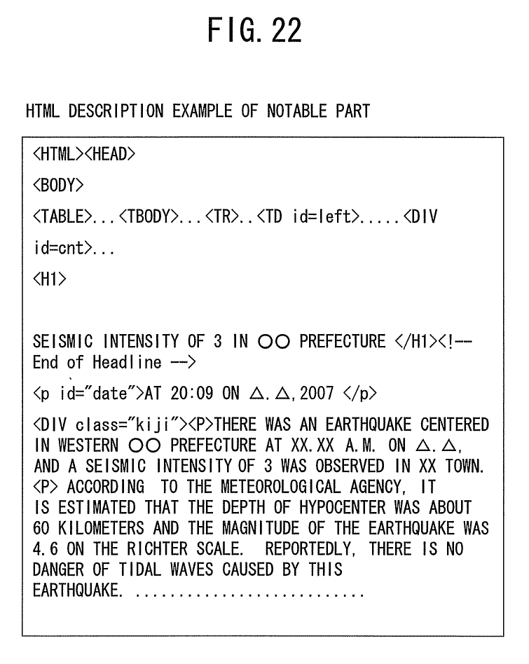

FIG. 22 illustrates a HTML description example in which the notable part is supplemented by the tags of the parent elements. Thus, even if a divided Web page is transmitted to the user terminal, it is possible to display the Web page without breaking its layout.

(5-2) Variation 2

In Embodiment 1 described above, the GW server 20 mediates the communication between the user terminal 10 and the Web server 1; however, the user terminal 10 and the Web server 1 may directly communicate with each other.

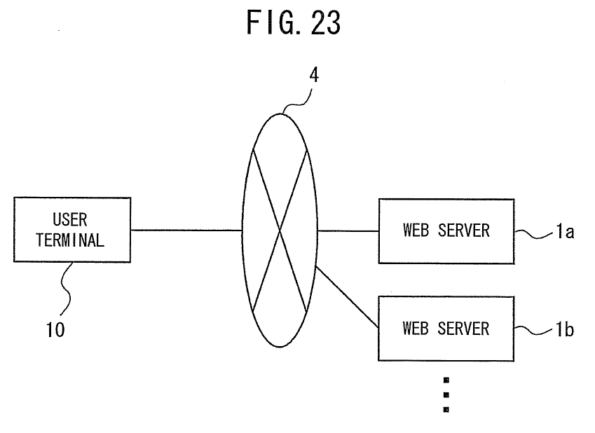

FIG. 23 illustrates a network configuration diagram according to Variation 2 of the present invention. The Web server 1 (1a, 1b . . . ) and the user terminal 10 are connected via a network 4.

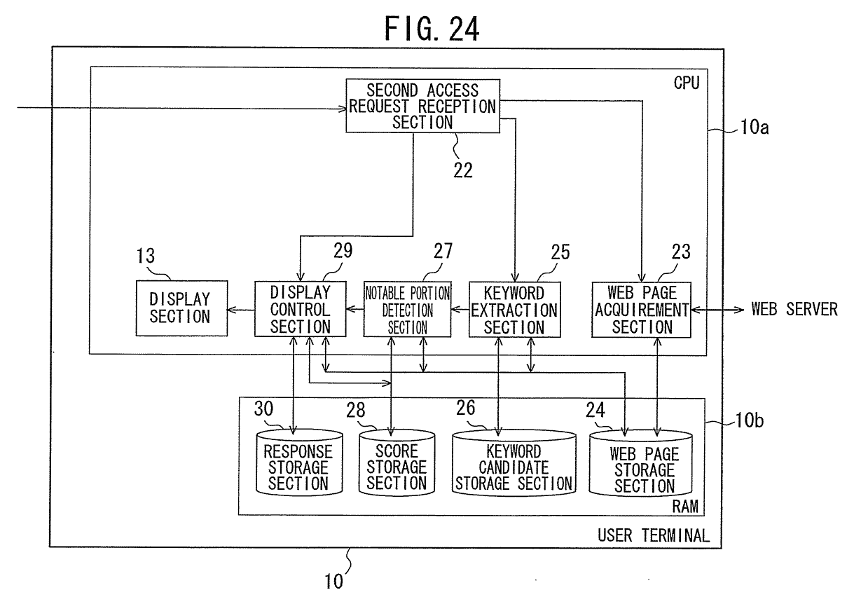

FIG. 24 illustrates a block diagram illustrating a hardware configuration and a functional configuration of a user terminal according to Variation 2. The user terminal 10 according to Variation 2 includes a CPU 10a, a RAM 10b, an undepicted ROM, etc., and has the functional configuration of the GW server 20 of Embodiment 1 and the display 13 of the user terminal 10 of Embodiment 1.

A second access request receptor 22 receives a request for access to a Web page from a user, and transmits the access request to a Web page acquirer 23. The access request received by the Web page acquirer 23 includes, for example, the URL of the Web page, etc. A display controller 29 transmits a generated response to the display 13, and the display 13 displays the Web page in accordance with the response.

Other functional configurations are similar to those of Embodiment 1, which are identified with the same reference numerals, and therefore, the description thereof will be omitted.

(5-3) Variation 3

In Embodiment 1 described above, keyword candidates of the URL 1 page are extracted from link character strings within the URL 0 page; however, a search keyword and a link character string used for the selection of the URL 0 page may be determined as keyword candidates of the URL 1 page.

Hereinafter, other extraction example of keyword candidates and keyword extraction example will be described.

(i) Extraction of Keyword Candidates

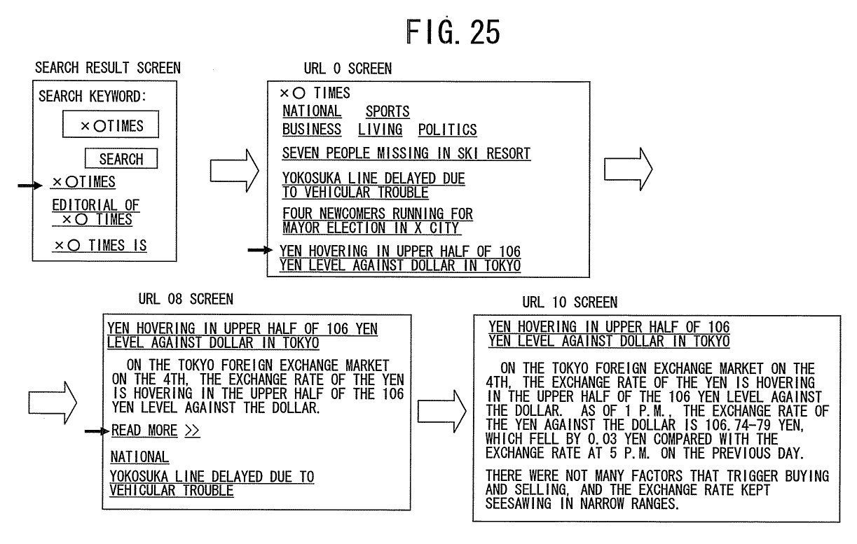

FIG. 25 illustrates a schematic diagram illustrating transition examples of Web pages. In FIG. 25, there are depicted screen examples in which notable parts split from respective Web pages are displayed. First, the user terminal 10 receives “×◯ TIMES” as a search keyword from the user, and acquires a search result page from the Web server 1. At this time, a search result screen depicted in FIG. 25 is displayed on the user terminal 10. On the search result screen, links within the search result page are displayed together with the search keyword inputted by the user.

Next, the user terminal 10 receives, from the user, the selection of “×◯ TIMES” among the links of the search result page. At this time, the display control process of the foregoing embodiment is performed, and the next URL 0 page is displayed from the notable part. At this moment, a URL 0 screen depicted in FIG. 25 is displayed on the user terminal 10. Next, the user terminal 10 receives, from the user, the selection of “YEN HOVERING IN UPPER HALF OF 106 YEN LEVEL AGAINST DOLLAR IN TOKYO” among the links of the URL 0 page, and displays a URL 08 page from the notable part.

Moreover, the user terminal 10 receives, from the user, the selection of “READ MORE” among the links of the URL 08 page, and displays a URL 10 screen.

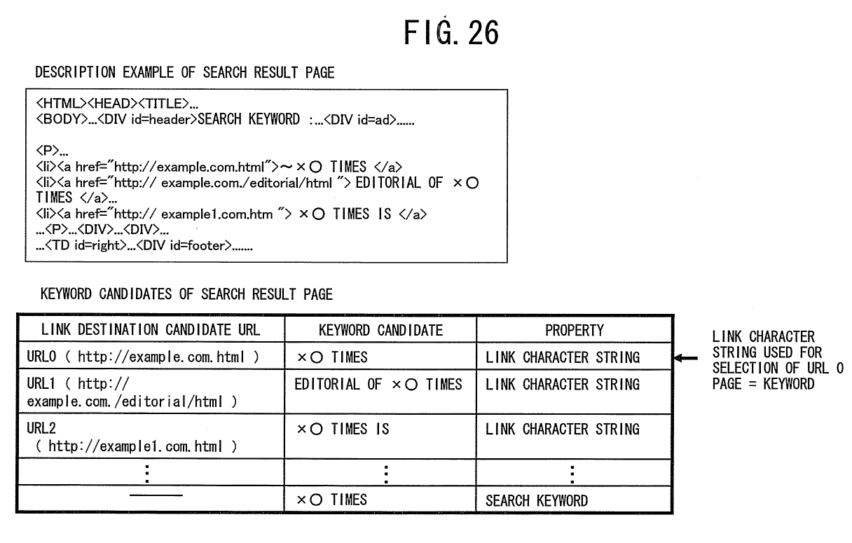

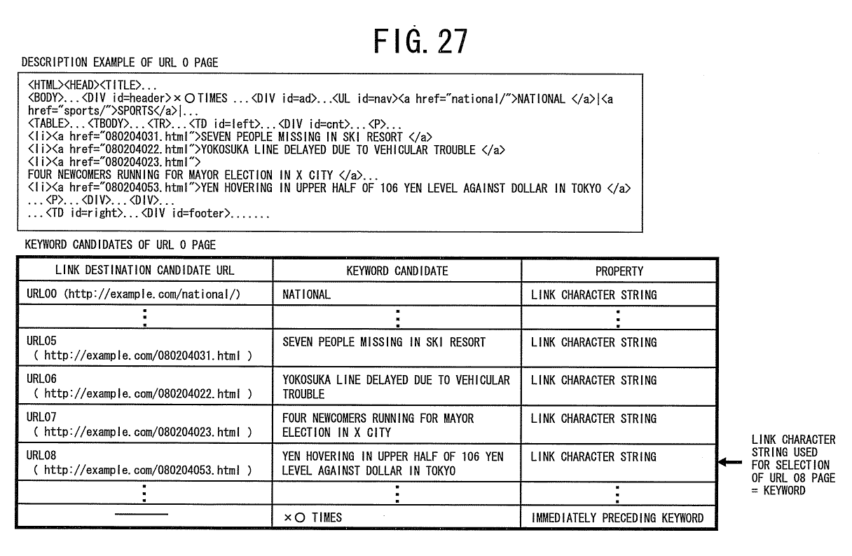

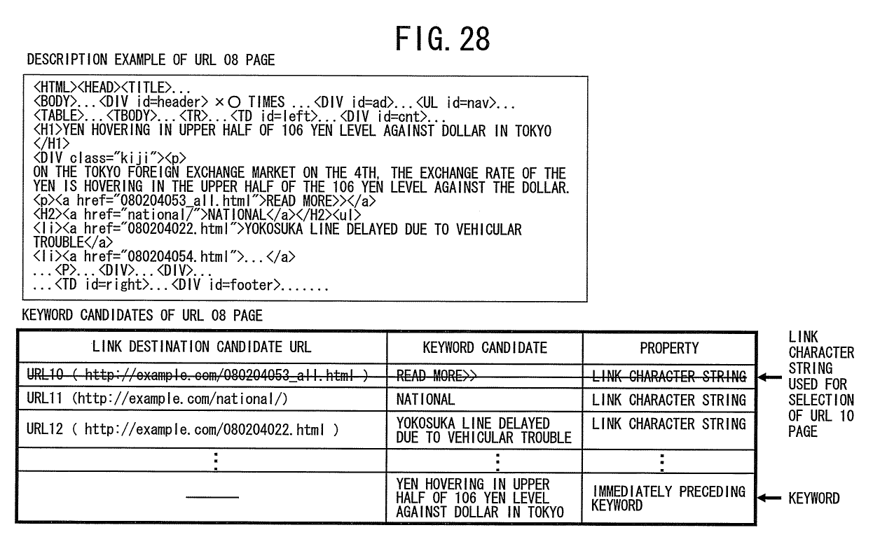

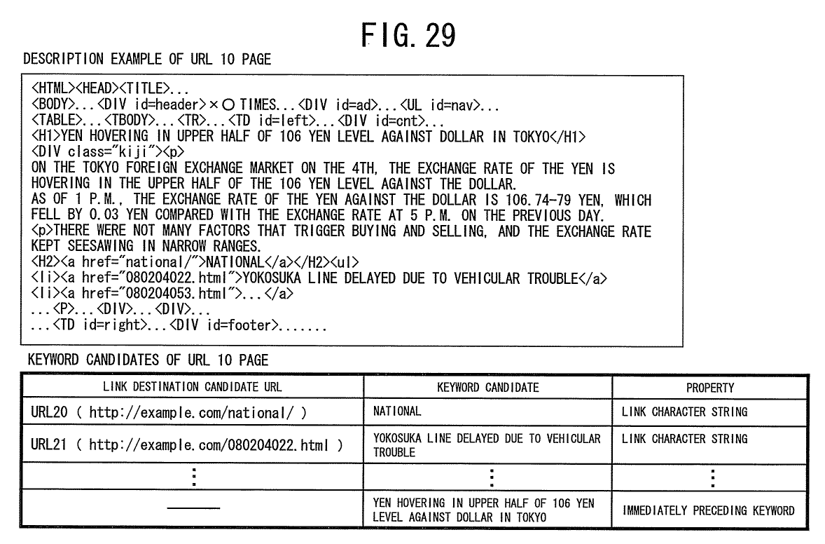

FIGS. 26 to 29 illustrate description examples of respective Web pages, keyword candidates and link destination candidate URLs extracted from the respective Web pages, and properties of the respective keyword candidates. FIG. 26 illustrates information of a search result page, FIG. 27 illustrates information of the URL 0 page, FIG. 28 illustrates information of the URL 08 page, and FIG. 29 illustrates information of the URL 10 page. These pieces of information are stored in the keyword candidate storage section 26.

As depicted in FIG. 26, the keyword extractor 25 extracts, as the keyword candidates, link character strings to which links are set from the search result page; in addition, the search keyword inputted by the user is included in the keyword candidates. In this embodiment, from a search keyword input screen, the URL 0 page is provided to the user terminal 10 via the search result screen. In this case, the search keyword may be relevant to the contents of the URL 0 page. Hence, the search keyword can be determined as the keyword candidate relevant to the URL 0 page.

Next, as depicted in FIG. 27, the keyword extractor 25 extracts link character strings within the URL 0 page as the keyword candidates. Moreover, the keyword extractor 25 extracts, as the keyword candidate, “×◯ TIMES” used for the selection from the search result page to the URL 0 page. In this embodiment, the property of the keyword used for the selection from the previous Web page to the current Web page will be referred to as an “immediately preceding keyword”. In this case, from the search result screen, the URL 08 page is provided via the URL 0 page. Hence, the link character string used for the selection of the link to the URL 0 page may be relevant to the contents of the URL 08 page, and this link character string may be determined as the keyword candidate relevant to the URL 08 page.

Similarly, as depicted in FIG. 28, the keyword extractor 25 extracts, as the keyword candidates, link character strings within the URL 08 page, and “YEN HOVERING IN UPPER HALF OF 106 YEN LEVEL AGAINST DOLLAR IN TOKYO” used for the selection from the URL 0 page to the URL 08 page. In this case, among the link character strings, “READ MORE” is determined as an NG word, and is not extracted as the keyword candidate. The NG word refers to a word poorly relevant to the next link destination Web page. For example, the URL 10 page selected due to the selection of the link of “READ MORE” is a Web page relevant to the contents of “YEN HOVERING IN UPPER HALF OF 106 YEN LEVEL AGAINST DOLLAR IN TOKYO”, but is poorly relevant to the meaning of the character string “READ MORE” itself. Therefore, when the link character string is an NG word, this link character string is not extracted as the keyword candidate.

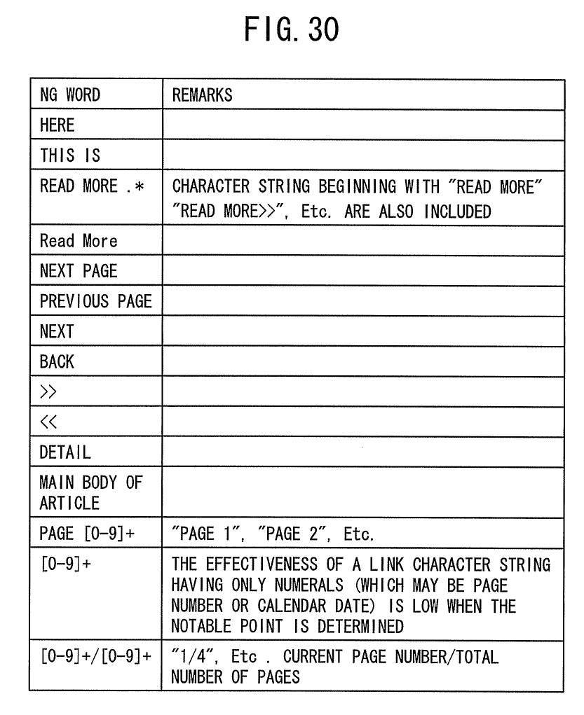

FIG. 30 illustrates an example of a list of NG words. When a link character string corresponds to any of these NG words, this link character string is not determined as the keyword candidate. In addition, also when the number of characters of a link character string is equal to or less than a given value, this link character string is not extracted as the keyword candidate.

Moreover, as depicted in FIG. 29, the keyword extractor 25 extracts link character strings within the URL 10 page as the keyword candidates. In this case, since “READ MORE” used for the selection from the URL 08 page to the URL 10 page is an NG word, “YEN HOVERING IN UPPER HALF OF 106 YEN LEVEL AGAINST DOLLAR IN TOKYO” used for the selection from the URL 0 page to the URL 08 page is extracted as the keyword candidate.

(ii) Keyword Extraction

The keyword extractor 25 extracts the keyword relevant to the next Web page from among the keyword candidates depicted in FIGS. 26 to 29. From among the keyword candidates depicted in FIG. 26, “×◯ TIMES” used for the selection of the URL 0 page is extracted as the keyword relevant to the URL 0 page.

Further, from among the keyword candidates depicted in FIG. 27, “YEN HOVERING IN UPPER HALF OF 106 YEN LEVEL AGAINST DOLLAR IN TOKYO” used for the selection of the URL 08 page is extracted as the keyword relevant to the URL 08 page. Furthermore, the keyword candidates depicted in FIG. 28 do not include “READ MORE” used for the selection of the URL 10 page. Therefore, the keyword extractor 25 extracts, as the keyword relevant to the URL 10 page, “YEN HOVERING IN UPPER HALF OF 106 YEN LEVEL AGAINST DOLLAR IN TOKYO”, which is the immediately preceding keyword.

(iii) Flow Of Keyword Candidate Extraction Process

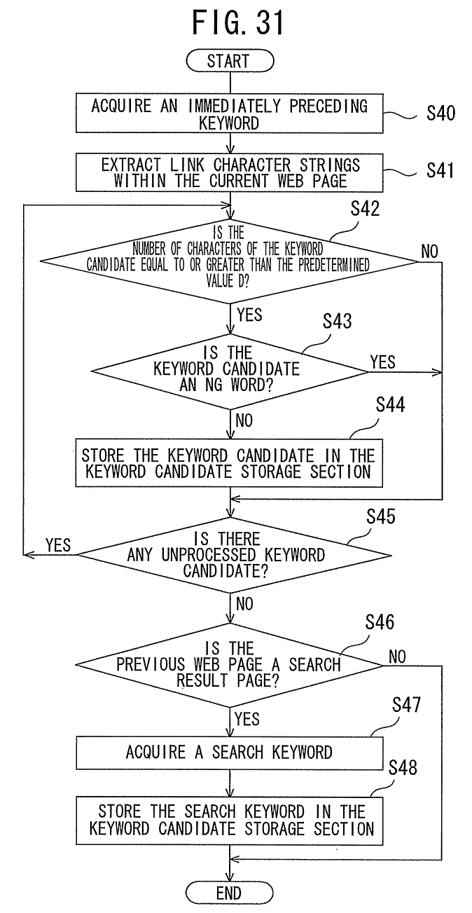

Next, a flow of a keyword candidate extraction process will be described. FIG. 31 illustrates an example of a flow chart illustrating the flow of the keyword candidate extraction process.

Operation S40: The keyword extractor 25 acquires, from the keyword candidate storage 26, an immediately preceding keyword used for the selection of the current Web page, and stores, as the keyword candidate of the current Web page, the immediately preceding keyword in the keyword candidate storage 26. For example, “×◯ TIMES” used for the selection of the current URL 0 page in FIG. 27 is extracted as the keyword candidate of the URL 0 page, and the property of “×◯ TIMES” is set as the immediately preceding keyword.

Operation S41: The keyword extractor 25 extracts link character strings within the current Web page.

Operation S42: It is determined whether the number of characters of each keyword candidate is equal to or greater than the given value D, and if the number of characters of each keyword candidate is equal to or greater than the given value D, the process proceeds to Operation S43. When the number of characters of the link character string is less than the given value D, the process proceeds to Operation S45 to exclude this link character string from the keyword candidates.

Operations S43 and S44: It is determined whether the keyword candidate is an NG word (S43), and when the keyword candidate is not an NG word, this keyword candidate is stored in the keyword candidate storage 26 (S44). When the keyword candidate is an NG word, the process proceeds to Operation S45 to exclude this keyword candidate from the keyword candidates.

Operation S45: When there is any unprocessed keyword candidate, the process returns to Operation S42. When there is no unprocessed keyword candidate, the process proceeds to Operation S46.

Operations S46 to S48: When the previous Web page is a search result Web page, the search keyword is acquired as the keyword candidate (S47), and is stored in the keyword candidate storage 26 (S48). It should be noted that if the next Web page is already selected when the keyword candidate is extracted in the current Web page, the following process may be added to the keyword candidate extraction process. It is determined whether the link character string used for the selection of the next Web page is an NG word, and when this link character string is an NG word, the link character string used for the selection of the Web page preceding the current Web page is added to the keyword candidates. For example, since “READ MORE” used for the selection of the URL 10 page is an NG word, “YEN HOVERING IN UPPER HALF OF 106 YEN LEVEL AGAINST DOLLAR IN TOKYO” used for the selection from the URL 0 page to the URL 08 page is extracted as the keyword candidate. Due to the function of reutilizing the immediately preceding keyword when the link character string or search character string is inappropriate as the keyword, the display can be effectively prevented from starting from an inappropriate part.

(5-4) Variation 4

Further, in Embodiment 1 described above, the keyword extractor 25 extracts all the link character strings within the URL 0 page as the keyword candidates. Thereafter, as the keyword relevant to the URL 1 page, the link character string relevant to the URL 1 page is extracted from among the keyword candidates. However, instead of performing the keyword candidate extraction, the link character string relevant to the URL 1 page may be directly extracted from the URL 0 page, and may be decided as the keyword relevant to the URL 1 page. For example, the keyword extractor 25 acquires the URL of the URL 1 page from the access request, and searches the URL 1 page to extract the keyword based on this URL.

In this case, the keyword extracted from the URL 1 page as described above, i.e., the link character string used for the selection of the URL 1 page, might correspond to any of the NG words depicted in FIG. 30 mentioned above. Hence, the keyword extractor 25 first determines whether the link character string used for the selection of the URL 1 page corresponds to any of the NG words. When the link character string corresponds to any of the NG words, the keyword extractor 25 acquires, as the keyword relevant to the URL 1 page, the search keyword used for the search of the URL 0 page, or the link character string used for the selection of the URL 0 page. Due to the function of reutilizing the immediately preceding keyword when the link character string or search character string is inappropriate as the keyword, the display can be effectively prevented from starting from an inappropriate part.

(5-5) Variation 5

The Web page dividing method is not limited to the foregoing method described in Embodiment 1. For example, a Web page may be divided into three parts, i.e., a notable part, a following part, and a previous part, without separating texts and images from each other. Further, a Web page may be simply divided into the following two parts: a notable part, and an accessory part other than this. Furthermore, a Web page may be divided more minutely than the foregoing embodiment.

(5-6) Variation 6

In addition to the URL of the access destination Web page, the access request may include a search keyword and/or a link character string used for selection. In the foregoing embodiment, the first access request receptor 11 receives a request for access to the URL 0 page based on the search keyword “×◯ TIMES”. Hence, the request for access to the URL 0 page includes “example.com” serving as the URL of the URL 0 page, and/or “×◯ TIMES” serving as the search keyword. Furthermore, the first access request receptor 11 receives a request for access to the URL 1 page due to the selection of the link of “SEISMIC INTENSITY OF 3 IN ◯◯ PREFECTURE”. Hence, the request for access to the URL 1 page includes “example.com/070920031.html” serving as the URL of the URL 1 page, and/or “SEISMIC INTENSITY OF 3 IN ◯◯ PREFECTURE”.

In this case, the keyword extractor 25 may decide the keyword based on the search keyword and link character string included in the access request.

(6) Operating Effects

When the request for access to the URL 1 page, serving as one of link destination Web pages, is made from the URL 0 page that is being displayed, the display priority of the notable part of the URL 1 page is set to be higher than that of the accessory part of the URL 1. Hence, when switching is performed from the URL 0 page, which is being displayed, to the URL 1 page, the URL 1 page is displayed preferentially from the notable part significantly relevant to the information desired by the user. For example, although a Web page also includes many pieces of information such as advertisements, which are information other than the information desired by the user, the notable part is preferentially displayed in the present embodiment. Hence, the user can quickly acquire the desired information, and furthermore, the number of operations, including scrolling of a screen performed in order to see the notable part, can be reduced.

Besides, in the above-described configuration, due to the function of transmitting the notable part to the user terminal first, the user can quickly acquire the desired information with a data transfer amount smaller than that when the entire URL 1 page is transferred; therefore, the data communication fee can be reduced, and the usage of a battery of the user terminal can be reduced. In addition, the keyword extractor 25 extracts a keyword from the URL 0 page. Hence, it is only necessary for the user to simply select the URL 1 page as the desired link destination Web page from the URL 0 page, and it is possible to quickly acquire the desired information without performing any new operation such as keyword input.

Further, in a user terminal with a small display area such as a PDA (Personal Digital Assistant) or a cellular phone, the number of operations performed to reach the desired information can be small, and the convenience of the user is enhanced.

### Embodiment 2

(1) Configuration

The network configuration and the configurations of the user terminal 10, GW server 20 and Web server 1 in Embodiment 2 are similar to those of Embodiment 1.

(2) Response Generation Process

In Embodiment 2, a jump mark is added to a notable part, thereby allowing the notable part to be displayed first. Therefore, the display controller 29, etc. perform the following operations. The operations other than those described below are similar to the operations of the response generation process of Embodiment 1, and therefore, the description thereof will be omitted. The display controller 29 acquires a notable portion from the notable portion detector 27, and adds a jump mark to the notable portion. Further, the display controller 29 generates a jump command for allowing a part of the URL 1 page, to which the jump mark is added, to be displayed first.

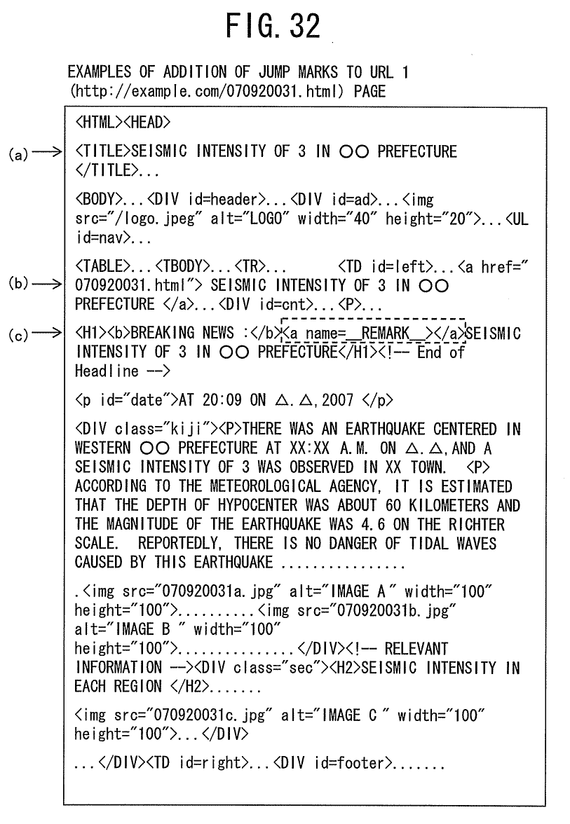

FIG. 32 illustrates examples of addition of jump marks to the URL 1 page. The display controller 29 adds a jump mark to a position preceding a portion corresponding to a keyword in a notable portion (c). In this case, “a name=”_REMARK_“></a>”, for example, is used as the jump mark. Furthermore, the display controller 29 generates the jump command using, for example, a HTTP response code 302 and a HTTP response of only “Location:URL1#_REMARK_”. The display controller 29 transmits, as the responses, the URL 1 page, to which the jump mark is added, and the jump command to the user terminal 10. The first transmitter/receptor 12 of the user terminal 10 receives these responses from the display controller 29, and temporarily stores them in the response cache 14. The display 13 displays the URL 1 page based on the URL 1 page to which the jump mark is added and the jump command stored in the response cache 14.

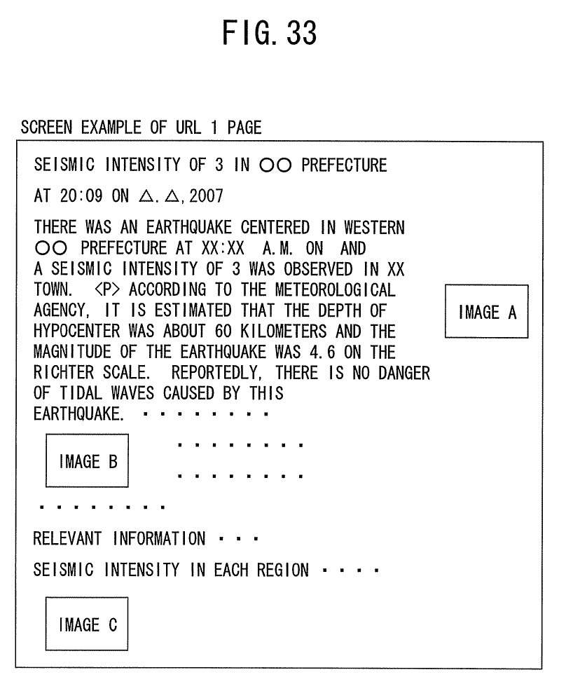

FIG. 33 illustrates a screen example of the URL 1 page when the display control process is performed. As depicted in FIG. 33, the user terminal 10 displays the URL 1 page from the notable part to which the jump mark is added. A combination of the jump mark and jump command is not limited to the foregoing combination. In addition, the following jump commands may be used.

“0;URL=URL1#_REMARK_” is designated for a Refresh header within a HTTP response header.

“<META HTTP-EQUIV=“refresh” Content=“0;URL=URL1#_REMARK_”>” is inserted into a html header in a body of a HTTP response.

As a script for performing a redirect process with a Java (registered trademark) Script, for example, “<body onload=‘window.location.replace(window.location.href+“#_REMARK_”) ;’>”, “setTimeout(window.location.replace(window.location.href+“#_REMARK_”),0)”, or the like is inserted.

(3) Process Flow

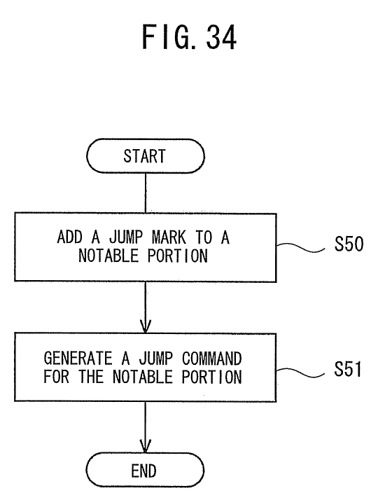

In the process flow, the response generation process of Embodiment 1 is replaced with the following process. Referring to FIG. 34, the flow of the response generation process according to Embodiment 2 will be described with respect to Operation S7 of FIG. 17 mentioned above. FIG. 34 illustrates an example of a flow chart illustrating the flow of the response generation process.

Operation S50: The display controller 29 adds a jump mark to a notable portion of the URL 1 page.

Operation S51: The display controller 29 generates a jump command for the notable portion. The display controller 29 transmits, as responses, the URL 1 page to which the jump mark is added and the jump command to the user terminal 10.

(4) Variation

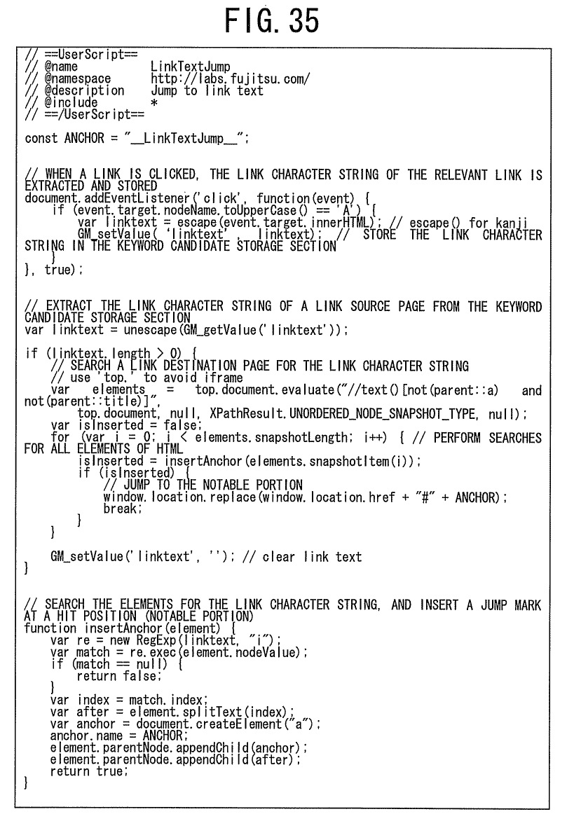

The configurations and variations of Embodiment 1 can be combined with Embodiment 2 as appropriate. In the case of the network configuration depicted in FIGS. 23 and 24 described above, the respective functional sections of the user terminal 10 perform processes to display the URL 1 page based on the script depicted in FIG. 35. FIG. 35 illustrates a description example of a process of each functional section.

(5) Operating Effects

When the URL 1 page is displayed, the user terminal displays the URL 1 page from a notable part, into which a jump mark is inserted, in accordance with a jump command. Hence, the URL 1 page is displayed preferentially from the notable part significantly relevant to information desired by the user, and therefore, the user can quickly acquire the desired information.

Further, in the case of providing a display control apparatus including the foregoing configurations, due to the function of allowing an existing Web browser to jump to a notable part, the number of screen scrolling operations performed in order to see the notable part can be reduced without modifying the existing browser, and the user can quickly browse the desired information.

### Other Embodiments

A system for executing the foregoing display control method, a computer program for allowing a computer to execute the display control method, and a computer-readable recording medium on which this program is recorded are included in the scope of the present invention. In the present invention, the computer-readable recording medium includes, for example, a flexible disk, a hard disk, a CD-ROM (Compact Disc-Read Only Memory), an MO (Magneto Optical disk), a DVD (Digital Video Disc), a DVD-ROM, a DVD-RAM (DVD-Random Access Memory), a BD (Blu-ray disc), and/or a semiconductor memory. The foregoing computer program is not limited to one that is recorded on the foregoing recording medium, but may be one transmitted via a telecommunications line, a wireless or wired communication line, a network typified by the Internet, etc.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A display control apparatus for acquiring a Web page from a Web server to transmit the Web page to a user terminal,
the display control apparatus comprising:
an access request receptor for receiving, from the user terminal, a request for access to a second Web page among link destination Web pages of a first Web page in which a link to one or a plurality of the link destination Web pages is embedded;
a keyword extractor for extracting, from the first Web page, a keyword relevant to the second Web page;
a notable portion detector for detecting a notable portion, serving as a portion relevant to the keyword, in the second Web page; and
a display controller for setting a display priority of a notable part including the notable portion of the second Web page so that the display priority of the notable part is higher than that of an accessory part serving as a part other than the notable part.

2. The display control apparatus according to claim 1,
wherein the display controller divides the second Web page into the notable part and the accessory part,
wherein the display controller sets the display priority of the notable part to be higher than that of the accessory part, and
wherein the display control apparatus further comprises a transmitter for transmitting each part of the divided second Web page to the user terminal in descending order of the display priorities.

3. The display control apparatus according to claim 2,
wherein the display controller further divides the accessory part into a previous part appearing before the notable part, and a following part appearing after the notable part, and
wherein the display controller sets the display priorities in the following increasing order: the previous part, the following part, and the notable part.

4. The display control apparatus according to claim 1,
wherein the display controller analyzes a structured document describing the second Web page,
wherein the display controller identifies a parent element of an element including the notable portion,
wherein the display controller extracts sibling elements of the parent element, whose appearance positions are posterior to that of the parent element, in the order of appearance in the structured document, and
wherein the display controller determines, as the notable part, a part sandwiched between a start-tag of the parent element, and an end-tag of the sibling element whose appearance position is the last among the extracted sibling elements.

5. The display control apparatus according to claim 4,
wherein the display controller sequentially extracts, in the order of appearance in the structured document from the element including the notable portion, parent elements whose appearance positions are anterior to that of the element, and
wherein the display controller supplements the notable part with a start-tag (and an end-tag) of each parent element in sequence.

6. The display control apparatus according to claim 1,
wherein the notable part includes a text and an image, and
wherein the display controller sets the display priority of the text to be higher than that of the image.

7. The display control apparatus according to claim 1,
wherein the display controller adds a jump mark to the notable part in order to set the display priority of the notable part at a high level,
wherein the display controller generates a jump command for allowing the second Web page to be displayed from its part to which the jump mark is added, and
wherein the display control apparatus further comprises a transmitter for transmitting the second Web page to which the jump mark is added and the jump command to the user terminal.

8. The display control apparatus according to claim 1,
wherein among link character strings to which the link is set in the first Web page, the keyword extractor extracts, as a keyword relevant to the second Web page, the link character string associated with the request for access to the second Web page.

9. The display control apparatus according to claim 8,
wherein the access request receptor further receives, from the user terminal, a request for access to the first Web page including a search character string, and
wherein the keyword extractor determines relevance between the extracted keyword relevant to the second Web page and the second Web page, and sets the search character string as the keyword relevant to the second Web page in accordance with the determination result.

10. The display control apparatus according to claim 8,
wherein the access request receptor further receives, from the user terminal, a request for access to the first Web page among the link destination Web pages of a given Web page in which a link to one or a plurality of the link destination Web pages is embedded, and
wherein the keyword extractor determines relevance between the extracted keyword relevant to the second Web page and the second Web page, and extracts, as the keyword relevant to the second Web page, the link character string associated with the request for access to the first Web page among the link character strings to which the link is set in the given Web page.

11. The display control apparatus according to claim 8,
the display control apparatus comprising a keyword candidate storage section for storing, as keyword candidates, the link character strings to which the link is set in the first Web page,
wherein among the keyword candidates, the keyword extractor extracts, as the keyword relevant to the second Web page, the keyword candidate associated with the request for access to the second Web page.

12. The display control apparatus according to claim 1,
wherein when a plurality of candidate portions are each detected as the notable portion, the notable portion detector calculates the importance of each candidate portion, and
wherein the notable portion detector decides the candidate portion having the highest importance as the notable portion.

13. A user terminal for acquiring a Web page from a Web server to display the Web page,
the user terminal comprising:
an access request receptor for receiving a request for access to a second Web page among link destination Web pages of a first Web page in which a link to one or a plurality of the link destination Web pages is embedded;
a keyword extractor for extracting, from the first Web page, a keyword relevant to the second Web page;
a notable portion detector for detecting a notable portion serving as a portion relevant to the keyword in the second Web page;
a display controller for setting a display priority of a notable part including the notable portion of the second Web page so that the display priority of the notable part is higher than that of an accessory part serving as a part other than the notable part; and
a display for displaying the second Web page in accordance with the display priority.

14. A display control system in which a display control apparatus for acquiring a Web page from a Web server is connected via a network to a user terminal for receiving the Web page from the display control apparatus to display the Web page,
the user terminal comprising:
a first access request receptor for receiving a request for access to a second Web page among link destination Web pages of a first Web page in which a link to one or a plurality of the link destination Web pages is embedded;
an access request transmitter for transmitting the request for access to the second Web page to the display control apparatus; and
a display for displaying the second Web page based on a display priority added to the second Web page,
the display control apparatus comprising:
a second access request receptor for receiving, from the access request transmitter, the request for access to the second Web page;
a keyword extractor for extracting, from the first Web page, a keyword relevant to the second Web page;
a notable portion detector for detecting a notable portion serving as a portion relevant to the keyword in the second Web page;
a display controller for setting a display priority of a notable part including the notable portion of the second Web page so that the display priority of the notable part is higher than that of an accessory part serving as a part other than the notable part; and
a transmitter for transmitting the second Web page to the user terminal.

15. A display control method for acquiring a Web page from a Web server to transmit the Web page to a user terminal,
the display control method comprising:
receiving a request for access to a second Web page among link destination Web pages of a first Web page in which a link to one or a plurality of the link destination Web pages is embedded from the user terminal;
extracting a keyword relevant to the second Web page from the first Web page;
detecting a notable portion, serving as a portion relevant to the keyword, in the second Web page; and
setting a display priority of a notable part including the notable portion of the second Web page so that the display priority of the notable part is higher than that of an accessory part serving as a part other than the notable part.

16. A recording medium storing a display control program executed by a computer for acquiring a Web page from a Web server to transmit the Web page to a user terminal,
the display control program comprising:
an access request reception process for receiving, from the user terminal, a request for access to a second Web page among link destination Web pages of a first Web page in which a link to one or a plurality of the link destination Web pages is embedded;
a keyword extraction process for extracting, from the first Web page, a keyword relevant to the second Web page;
a notable portion detection process for detecting a notable portion, serving as a portion relevant to the keyword, in the second Web page; and
a display control process for setting a display priority of a notable part including the notable portion of the second Web page so that the display priority of the notable part is higher than that of an accessory part serving as a part other than the notable part.
